(19) United States
(12) Patent Application Publication
(10) Pub. No.: US 2026/0273819 A1
(43) Pub. Date: Sep. 17, 2026

(54) COUPLING DEVICE AND MOLTEN RESIN SUPPLY SYSTEM

(71) Applicant: SUMITOMO HEAVY INDUSTRIES, LTD., Tokyo (JP)

(72) Inventors: Tsutomu MIYATAKE, Chiba-shi (JP); Ryuichi TAKANOHASHI, Tokyo (JP)

(21) Appl. No.: 19/547,494

(22) Filed: Feb. 23, 2026

Related U.S. Application Data
(63) Continuation of application No. PCT/JP2024/030594, filed on Aug. 28, 2024.

(30) Foreign Application Priority Data
Aug. 29, 2023 (JP) 2023-138922

(51) Int. Cl. B29C 45/17; B29C 45/18; B29K 105/26

(52) U.S. Cl. CPC B29C 45/1775; B29C 45/18; B29K 2105/26

(57) ABSTRACT

A coupling device that couples an output unit outputting molten resin to be recycled from an outlet to an injection molding machine including a plasticizing cylinder that includes an inlet through which the output molten resin is input and that heats the molten resin and an injection cylinder that is independent of the plasticizing cylinder and that injects the heated molten resin into a mold, the coupling device includes tubes and swivel joints through which the molten resin passes, in which the coupling device couples the output unit to the injection molding machine with one end of a pipe formed by the tubes and the swivel joints being connected to the outlet and the other end of the pipe being connected to the inlet.

### CROSS-REFERENCE TO RELATED APPLICATIONS

This is a bypass continuation of International PCT Application No. PCT/JP2024/030594, filed on Aug. 28, 2024, which claims priority to Japanese Patent Application No. 2023-138922, filed on Aug. 29, 2023, which are incorporated by reference herein in their entirety.

### BACKGROUND

### Technical Field

Certain embodiments of the present invention relate to a coupling device and a molten resin supply system.

### Description of Related Art

There is a case where a decontamination machine and an injection molding machine are coupled to each other via a pipe so that molten resin that is output from the decontamination machine is directly input to the injection molding machine, the decontamination machine removing a contaminant contained in resin to be recycled through a mechanical recycling method. In such a case, a coupling of the pipe may be provided with a sleeve (a slip expansion pipe coupling) to cope with positional movement of a plasticizing cylinder of the injection molding machine that occurs as the molten resin in the plasticizing cylinder is discharged (purged) or the like (for example, refer to the related art).

### SUMMARY

One or more embodiments provide a coupling device that couples an output unit outputting molten resin to be recycled from an outlet to an injection molding machine including a plasticizing cylinder that includes an inlet through which the output molten resin is input and that heats the molten resin and an injection cylinder that is independent of the plasticizing cylinder and that injects the heated molten resin into a mold, the coupling device including tubes and swivel joints through which the molten resin passes, in which the coupling device couples the output unit to the injection molding machine with one end of a pipe formed by the tubes and the swivel joints being connected to the outlet and the other end of the pipe being connected to the inlet.

Here, the number of the swivel joints provided for the coupling device may be three.

In addition, the swivel joints may include seal members, each having a predetermined heat-proof temperature and a predetermined proof pressure.

In addition, the coupling device may heat the molten resin passing through the pipe by heating the pipe.

In addition, the coupling device may heat the pipe using a band heater.

In addition, the swivel joints may be rotatable via sliding bearings, and a portion of the molten resin may be used as a lubricant for the sliding bearings.

In addition, orientations of rotary shafts of the swivel joints may not be parallel to a vertical direction and may be approximately perpendicular to a direction in which the plasticizing cylinder moves.

In addition, a virtual straight line connecting the one end and the other end of the pipe to each other may be approximately parallel to a direction in which the plasticizing cylinder moves.

In addition, a virtual straight line connecting the one end and the other end of the pipe to each other may be approximately orthogonal to rotary shafts of the swivel joints.

In addition, each of a length of a first pipe portion of the pipe that includes a swivel joint closest to the one end and a length of a third pipe portion of the pipe that includes a swivel joint farthest from the one end may be equal to or smaller than 30% of a length of a second pipe portion of the pipe that includes a swivel joint disposed between the first pipe portion and the third pipe portion.

In addition, one or more embodiments provide a molten resin supply system including the output unit, the injection molding machine, and the coupling device, in which a position of the outlet of the output unit is fixed, and a position of the inlet of the plasticizing cylinder is moved in accordance with positional movement of the plasticizing cylinder.

In addition, one or more embodiments provide a molten resin supply system including the output unit, the injection molding machine, and the coupling device, in which virtual straight lines that connect respective rotary shafts of three swivel joints to each other do not form one straight line as seen in a vertical direction even when the output unit and the injection molding machine are relatively moved or a process of preventing the virtual straight lines from forming one straight line as seen in the vertical direction is performed, the three swivel joints being coupled to each other via two tubes.

In addition, the output unit or the injection molding machine may perform control for reducing internal pressures of the swivel joints depending on magnitudes of the internal pressures of the swivel joints.

In addition, the output unit or the injection molding machine may perform, as the control, control for lowering a pressure at which the molten resin is output from the outlet.

In addition, the output unit or the injection molding machine may perform, as the control, control of at least one of outputting of the molten resin from the output unit and inputting of the molten resin to the injection molding machine.

In addition, the output unit may calculate the magnitudes of the internal pressures based on information detected at each of molten resin inlets and molten resin outlets of the swivel joints.

In addition, a position of the outlet of the output unit in a vertical direction and a position of the inlet of the injection molding machine in the vertical direction may be on approximately the same horizontal straight line.

### BRIEF DESCRIPTION OF THE DRAWINGS

FIG. 1 is a front view showing a part of an external appearance configuration of a molten resin supply system including a coupling device, according to a first embodiment.

FIG. 2 is a schematic configuration view of an injection molding machine constituting the molten resin supply system.

FIG. 3 is a view showing a change in positional relationship between swivel joints.

FIG. 4 is a front view showing a part of an external appearance configuration of a molten resin supply system including a coupling device, according to a second embodiment.

FIG. 5 is a front view showing a part of an external appearance configuration of a molten resin supply system including a coupling device, according to a third embodiment.

FIG. 6 is a front view showing a part of an external appearance configuration of a molten resin supply system including a coupling device, according to a fourth embodiment.

FIG. 7 is a front view showing a part of an external appearance configuration of a molten resin supply system, according to a fifth embodiment.

FIG. 8 is a plan view showing a part of the external appearance configuration of the molten resin supply system, according to the fifth embodiment.

FIG. 9 is a plan view showing a part of an external appearance configuration of a molten resin supply system, according to a sixth embodiment.

FIGS. 10A and 10B are front views showing a part of an external appearance configuration of a molten resin supply system, according to a seventh embodiment.

### DETAILED DESCRIPTION

In a case where a sleeve is provided as a coupling of a pipe, the sleeve slides to enter and exit the pipe in accordance with positional movement of the plasticizing cylinder. In this case, molten resin passing through the inside of the pipe may be exposed outside the pipe in a state of adhering to a surface of the sleeve. Therefore, when the sleeve slides, the exposed molten resin may be rubbed and carbonized or molten resin passing through the inside of the pipe may be deteriorated with carbonized resin being mixed with the molten resin.

According to the present invention, it is possible to suppress leakage of molten resin passing through a pipe from a coupling in comparison with a case where a sleeve that serves as a coupling of a pipe connecting a device that outputs molten resin and an injection molding machine to each other is provided.

Hereinafter, embodiments of the present invention will be described in detail with reference to the accompanying drawings.

### First Embodiment

### Configuration of Molten Resin Supply System

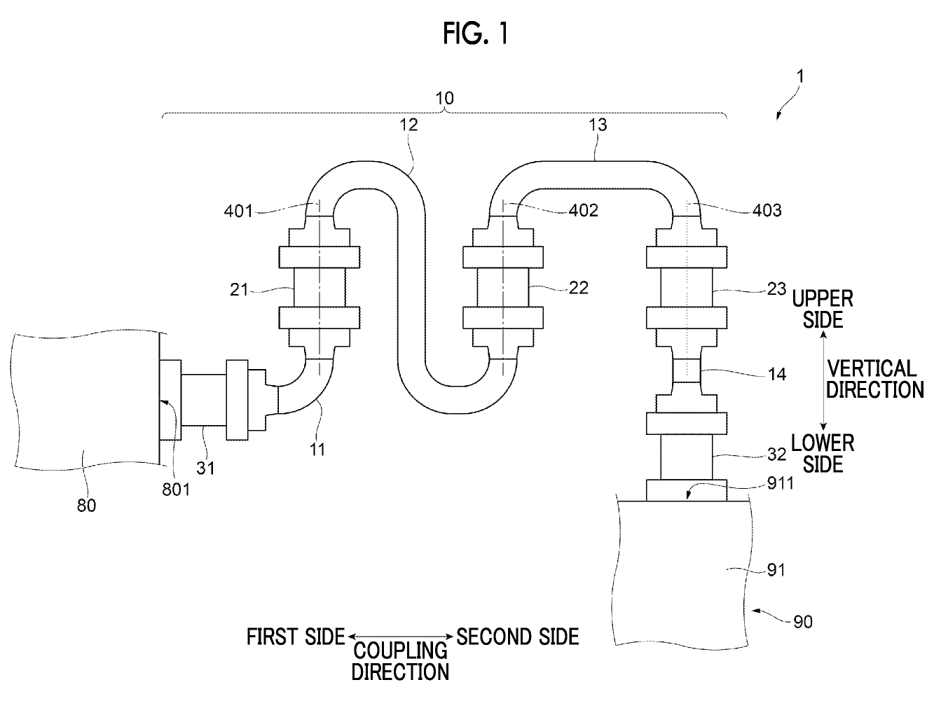

FIG. 1 is a front view showing a part of an external appearance configuration of a molten resin supply system 1 including a coupling device 10 according to a first embodiment.

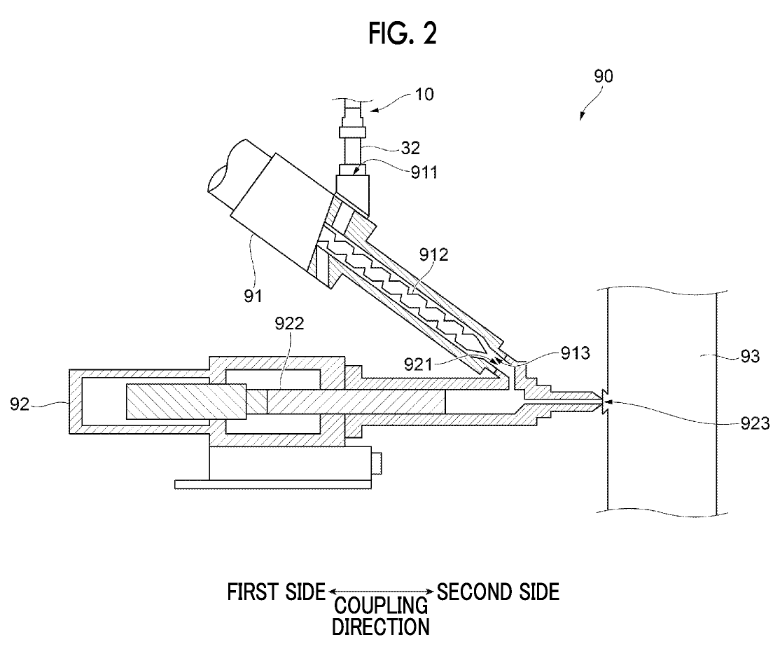

FIG. 2 is a schematic configuration view of an injection molding machine 90 constituting the molten resin supply system 1.

The molten resin supply system 1 shown in FIG. 1 is a system configured to include the coupling device 10, a decontamination machine 80 which is an example of an output unit outputting molten resin, and the injection molding machine 90. The coupling device 10 is a device consisting of a pipe that couples the decontamination machine 80 and the injection molding machine 90 to each other, the decontamination machine 80 being disposed on a first side in a direction (hereinafter, referred to as a “coupling direction”) in which the decontamination machine 80 and the injection molding machine 90 are coupled to each other, the injection molding machine 90 being disposed on a second side. Note that the expression “coupling direction” does not mean a strict positional relationship between the decontamination machine 80 and the injection molding machine 90 which are coupled to each other by the coupling device 10. Hereinafter, an expression “a direction in which a plasticizing cylinder 91 of the injection molding machine 90 moves” may be used as an expression meaning the same direction as the coupling direction. The coupling device 10 is configured to include tubes 11 to 14, swivel joints 21 to 23, and connecting members 31 and 32, and the tubes 11 to 14, the swivel joints 21 to 23, and the connecting members 31 and 32 form a pipe having a meandering shape meandering in a vertical direction by being coupled to each other.

The tubes 11 to 14 are metal tubes through which molten resin passes and that each have a circular cross-sectional shape. Among these, the tube 11 is a tube of which one end is connected to the connecting member 31 and of which the other end is connected to the swivel joint 21. The tube 11 has a curved shape that causes molten resin flowing from the first side to the second side in the coupling direction to flow to an upper side in the vertical direction. The tube 12 is a tube of which one end is connected to the swivel joint 21 and of which the other end is connected to the swivel joint 22. The tube 12 has a meandering shape that causes molten resin flowing from a lower side to the upper side in the vertical direction to flow to the second side in the coupling direction, the lower side in the vertical direction, the second side in the coupling direction, and the upper side in the vertical direction in this order.

The tube 13 is a tube of which one end is connected to the swivel joint 22 and of which the other end is connected to the swivel joint 23. The tube 13 has a curved shape that causes molten resin flowing from the lower side to the upper side in the vertical direction to flow to the second side in the coupling direction and the lower side in the vertical direction in this order. The tube 14 is a tube of which one end is connected to the swivel joint 23 and of which the other end is connected to the connecting member 32. The tube 14 has a linear shape that causes molten resin flowing from the upper side to the lower side in the vertical direction to flow to the lower side as it is.

The swivel joint 21 is a swivel joint of which an end portion on the lower side in the vertical direction is connected to the tube 11 and of which an end portion on the upper side is connected to the tube 12. A rotary shaft 401 of the swivel joint 21 enables rotation of the tubes 11 and 12. Here, a swivel joint is a coupling that rotatably couples a plurality of tubes. Although not shown, a swivel joint includes a shaft portion and a bearing that enable rotation around a center axis of a pipe connected to the swivel joint, a seal member that prevents leakage of a fluid (molten resin in the present embodiment) passing through the inside of the swivel joint, and a grease encapsulation portion in which grease serving as a lubricant maintaining smooth rotation of the shaft portion is encapsulated. Note that a grease nipple serving a supply port for supply of grease may also be provided. A swivel joint and a tube are connected to each other by being fixed with a bolt or the like with a rubber O-ring serving as a seal member interposed therebetween.

A bearing of a swivel joint is configured as a so-called “rolling bearing” which rotates a shaft portion via steel balls or a bearing or a so-called “sliding bearing” which comes into direct contact with a shaft portion and of which a surface receives rotation of the shaft portion. Note that rolling bearings are adopted as bearings of the swivel joints 21 to 23 according to the present embodiment. However, in the present embodiment, the rolling bearings can be changed to sliding bearings depending on the heat-proof temperature and the proof pressure of the insides of the swivel joints 21 to 23.

A seal member of a swivel joint has a predetermined heat-proof temperature and a predetermined proof pressure. The heat-proof temperature and the proof pressure of the seal member are determined by the physical properties of resin to be recycled and the pressure (for example, the amount of molten resin or the like) in the coupling device 10. For example, in a case where resin to be recycled is polyethylene terephthalate (PET resin), it is preferable that the seal member can withstand a temperature and a pressure for transportation of PET resin in a molten state.

Specifically, for example, it is preferable that the heat-proof temperature is set to 300° C as a temperature higher than the melting point of homopolymer type PET resin with a small margin and that the proof pressure is set to 25MPa (megapascal) as a pressure higher than a pressure expected to be required from various conditions including the amount of resin that is input toward the coupling device 10 from an outlet 801 of the decontamination machine 80 and that is output toward an inlet 911 of the injection molding machine 90 from the coupling device 10 with a margin.

In a case where the heat-proof temperature and the proof pressure of the seal member are in a trade-off relationship, deterioration of the seal member can be suppressed when the internal pressure of the swivel joint is lowered since the heat-proof temperature of the seal member is increased. Note that a method of lowering the internal pressure of each of the swivel joints 21 to 23 according to the present embodiment will be described later. In addition, in a case where resin to be recycled is changed, the heat-proof temperature is determined to be slightly higher than the melting point of the resin.

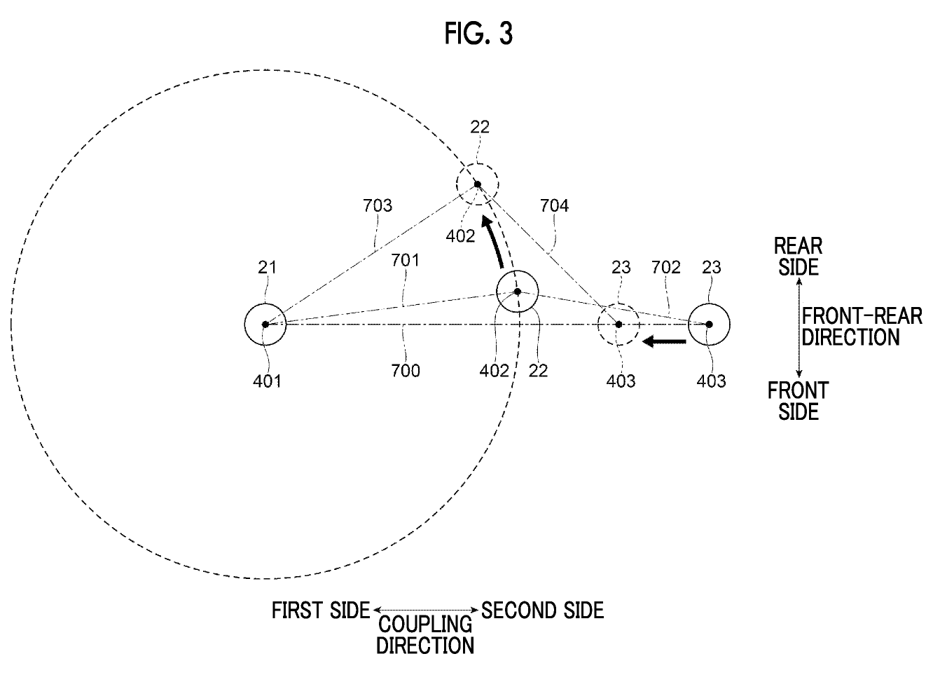

The swivel joint 22 is a swivel joint of which an end portion on the lower side in the vertical direction is connected to the tube 12 and of which an end portion on the upper side is connected to the tube 13. A rotary shaft 402 of the swivel joint 22 enables rotation of the tubes 12 and 13. In addition, in accordance with a positional change of the swivel joint 23 (which will be described later) in the coupling direction, the position of the swivel joint 22 is changed in a circumferential direction around the rotary shaft 401 of the swivel joint 21 and a circumferential direction around a rotary shaft 403 of the swivel joint 23 of which the position is changed. Note that a positional change of the swivel joint 22 will be described later with reference to FIG. 3.

The swivel joint 23 is a swivel joint of which an end portion on the upper side in the vertical direction is connected to the tube 13 and of which an end portion on the lower side is connected to the tube 14. The rotary shaft 403 of the swivel joint 23 enables rotation of the tubes 13 and 14. In addition, when the position of the plasticizing cylinder 91 of the injection molding machine 90 is moved, the position of the swivel joint 23 changes in accordance with the movement. The position of the plasticizing cylinder 91 is moved when, for example, molten resin is discharged (purged) from the plasticizing cylinder 91, and does not involve movement of the entire injection molding machine 90. Note that a positional change of the swivel joint 23 will be described later with reference to FIG. 3.

In addition, the coupling device 10 according to the first embodiment forms four paths extending in the vertical direction as shown in FIG. 1. Therefore, four swivel joints can be respectively disposed for the paths. However, three swivel joints (the swivel joints 21 to 23) are disposed in total. That is, for one (a path formed by the tube 12) of the four paths extending in the vertical direction, no swivel joint is disposed on purpose even though a swivel joint can be disposed. This is because an increase in the number of disposed swivel joints makes the trajectory of the pipe unstable and various costs also increase, although the number of swivel joints that can be disposed is not limited. Therefore, in consideration of the stability of the trajectory of the pipe and the cost, it is preferable that the number of swivel joints disposed is three.

The connecting member 31 is a member for connecting the coupling device 10 to the decontamination machine 80 (which will be described later), and is fixed to the decontamination machine 80 by a flange or the like. Specifically, an end portion of the connecting member 31 that is on the first side in the coupling direction is connected to the outlet 801 of the decontamination machine 80, and an end portion of the connecting member 31 that is on the second side in the coupling direction is connected to the tube 11. The connecting member 31 and the tube 11 are connected to each other by being fixed with a bolt or the like with a rubber O-ring serving as a seal member interposed therebetween.

The connecting member 32 is a member for connecting the coupling device 10 to the injection molding machine 90 (which will be described later), and is fixed to the injection molding machine 90 by a flange or the like. Specifically, an end portion of the connecting member 32 that is on the upper side in the vertical direction is connected to the tube 14, and an end portion of the connecting member 32 that is on the lower side in the vertical direction is connected to the inlet 911 provided in the plasticizing cylinder 91 of the injection molding machine 90. The connecting member 32 and the tube 14 are connected to each other by being fixed with a bolt or the like with a rubber O-ring serving as a seal member interposed therebetween.

In addition, in the case of a configuration in which the coupling device 10 can control a gear pump (not shown) disposed in the decontamination machine 80, the coupling device 10 can lower the internal pressure of the coupling device 10 and lower the internal pressure of each of the swivel joints 21 to 23 by reducing the amount of molten resin output from the outlet 801 of the decontamination machine 80.

The decontamination machine 80 is a device that removes a contaminant contained in resin such as a PET bottle to be recycled through a mechanical recycling method (a physical regeneration method) or a chemical recycling method (a chemical regeneration method) and that outputs the resin as molten resin. The “mechanical recycling” refers to a series of processes in which resin such as a used and collected PET bottle or the like is selected, crushed, and washed so that dirt or foreign matter on a surface is removed and then the resin is exposed to a high temperature so that a contaminant remaining in the molten resin is diffused and removed in a vacuum in the decontamination machine 80. In addition, the “chemical recycling” refers to a series of processes in which resin such as a used and collected PET bottle or the like is selected, chemically decomposed, and re-polymerized so that a contaminant is removed.

As described above, the decontamination machine 80 includes the outlet 801 for outputting decontaminated resin as molten resin. The connecting member 31 of the coupling device 10 is connected to the outlet 801, and molten resin decontaminated by the decontamination machine 80 is input to the coupling device 10 from the connecting member 31 connected to the outlet 801.

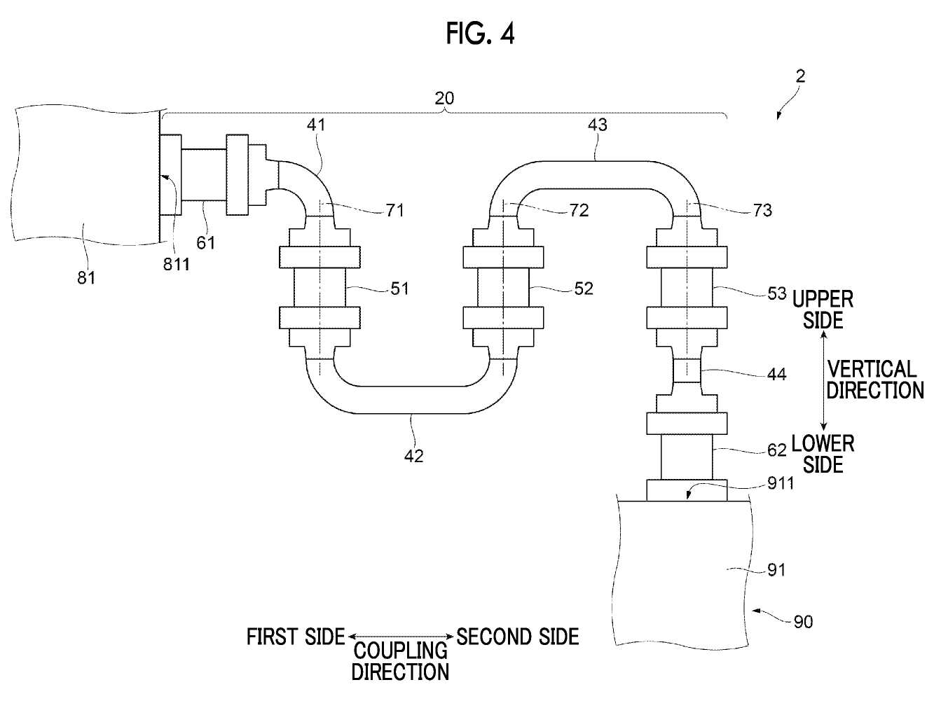

Here, the position of the outlet 801 of the decontamination machine 80 in the vertical direction is fixed to be on approximately the same horizontal straight line as the position of the inlet 911 of the injection molding machine 90 in the vertical direction so that generation of thermal stress on the coupling device 10 is suppressed. Note that a relationship between the position of the outlet 801 of the decontamination machine 80 in the vertical direction and the position of the inlet 911 of the injection molding machine 90 in the vertical direction will be described in comparison between the first embodiment and a second embodiment which will be described later with reference to FIG. 4.

The decontamination machine 80 performs control for reducing the internal pressure of each of the swivel joints 21 to 23 depending on the internal pressure of each of the swivel joints 21 to 23 of the coupling device 10. For example, the decontamination machine 80 may control, based on information detected at each of the connecting member 31 and the connecting member 32 which correspond to an inlet and an outlet of the coupling device 10, the outputting of molten resin to the coupling device 10 such that the internal pressure of the coupling device 10 is lowered and the internal pressure of each of the swivel joints 21 to 23 is lowered. Here, examples of the information detected at each of the connecting member 31 and the connecting member 32 include information about a molten resin flow rate (an input flow rate, an output flow rate, or the like) per unit time, information about the temperature of molten resin, and information about the pressure of molten resin, which are obtained from a flow rate sensor (not shown). The pressure of molten resin can also be identified based on the amount of molten resin in the coupling device 10 that is specified from the amount of molten resin input to the coupling device 10 and the amount of molten resin output from the coupling device 10.

Specifically, for example, in a case where the content of the information detected at each of the connecting member 31 and the connecting member 32 indicates an abnormality (an abnormality in pressure or temperature), the decontamination machine 80 may perform control to stop outputting molten resin to the coupling device 10 so that the internal pressure of each of the swivel joints 21 to 23 is lowered. In addition, for example, in a case where the content of the information detected at each of the connecting member 31 and the connecting member 32 does not indicate an abnormality but indicates that there will be an abnormality in a case where there is no change although the degree of urgency is low, the decontamination machine 80 may perform control of the outputting of molten resin to the coupling device 10 such that the internal pressure of the coupling device 10 is lowered and the internal pressure of each of the swivel joints 21 to 23 is lowered.

For example, the decontamination machine 80 may control, based on information detected at each of a molten resin inlet and a molten resin outlet of each of the swivel joints 21 to 23, the outputting of molten resin to the coupling device 10 such that the internal pressure of each of the swivel joints 21 to 23 is lowered. Here, examples of the information detected at each of the molten resin inlet and the molten resin outlet of each of the swivel joints 21 to 23 include information about a molten resin flow rate per unit time, which is obtained from a flow rate sensor (not shown). Since the above-described control is performed, for example, in a case where the heat-proof temperature and the proof pressure of seal members (not shown) of the swivel joints 21 to 23 are in a trade-off relationship, the proof pressure of the seal members can be lowered so that the heat-proof temperature is increased.

Specifically, the decontamination machine 80 performs, as control of the outputting of molten resin to the coupling device 10, control for lowering a pressure at which molten resin is output from the outlet 801. In this case, although not shown, the decontamination machine 80 lowers a pressure at which molten resin is output through the outlet 801 by controlling the amount of resin output from a gear pump or the outlet 801, the gear pump being used to output molten resin.

Furthermore, the decontamination machine 80 may control the outputting of molten resin (a flow rate and a pressure) depending on the amount of molten resin used in the injection molding machine 90 or the amount of molten resin discharged from the injection molding machine 90. In this case, there is a case where it is difficult to perform control such that the amount of molten resin output is decreased such as a case where the decontamination machine 80 is continuously operated. Therefore, a member that serves as a buffer for temporarily retaining a surplus of molten resin or another path through which a surplus of molten resin flows may be provided. In addition, in a case where the amount of a surplus of molten resin is too large, the surplus of molten resin may be directed to another path for discarding the molten resin, or the decontamination machine 80 may be connected to an inlet of another injection molding machine so that the surplus of molten resin is supplied thereto.

In addition, in a case where the decontamination machine 80 can control the quantity of molding products (for example, products or preforms of the products) produced by the injection molding machine 90, the decontamination machine 80 may control the outputting of molten resin (a flow rate and a pressure) from the outlet 801 by increasing the quantity of molding products produced by the injection molding machine 90.

The injection molding machine 90 is a molding machine used when a molding product is to be manufactured by using molten resin as the material thereof. The injection molding machine 90 is coupled to the decontamination machine 80 via the coupling device 10. Therefore, the injection molding machine 90 can receive molten resin output and supplied from the decontamination machine 80 and can manufacture a molding product by using the molten resin as the material thereof. As shown in FIG. 2, the injection molding machine 90 is configured to include the plasticizing cylinder 91, an injection cylinder 92, and a mold 93. The injection molding machine 90 is a so-called pre-plunger type (also referred to as a pre-plasticizing type) injection molding machine obtained by combining the plasticizing cylinder 91 and the injection cylinder 92, which are independent of each other, with each other. Therefore, a longitudinal axis of the plasticizing cylinder 91 and a longitudinal axis (that is, the coupling direction) of the injection cylinder 92 are not present on the same axis.

The plasticizing cylinder 91 is a cylinder that heats molten resin serving as the material of a molding product and that feeds a necessary amount of molten resin into the injection cylinder 92. The plasticizing cylinder 91 is configured to include the inlet 911 for inputting molten resin, a screw 912 that heats the input molten resin, and an outlet 913 for outputting the heated molten resin. The plasticizing cylinder 91 heats molten resin by using the shear heat generated as the screw 912 rotates and heat of a band heater (not shown) and outputs the molten resin toward the injection cylinder 92 from the outlet 913. The band heater is configured as, for example, a lightweight and thin cylindrical heater in which a nichrome wire is insulated with a heat-resistant mica plate and is externally coated with a stainless steel plate. The band heater can be brought into close contact with a cylindrical pipe through a simple operation since an inner surface of the band heater that comes into contact with the pipe is smooth.

The injection cylinder 92 is a cylinder that injects molten resin into the mold 93. The injection cylinder 92 is configured to include an inlet 921 for inputting molten resin output from the outlet 913 of the plasticizing cylinder 91, a plunger 922 that pressurizes the input molten resin toward the second side in the coupling direction, and an injection port 923 through which the pressurized molten resin is injected into the mold 93. In the mold 93, the molten resin is molded through a mold opening and closing operation and is cooled and solidified so that a molding product (for example, a product or a preform of the product) is completed.

The injection molding machine 90 performs control for reducing the internal pressure of each of the swivel joints 21 to 23 depending on the internal pressure of each of the swivel joints 21 to 23 of the coupling device 10. For example, the injection molding machine 90 may control, based on information detected at each of the connecting member 31 and the connecting member 32 of the coupling device 10, the inputting of molten resin output from the coupling device 10 such that the internal pressure of the coupling device 10 is lowered and the internal pressure of each of the swivel joints 21 to 23 is lowered. Here, examples of the information detected at each of the connecting member 31 and the connecting member 32 include information about a molten resin flow rate (an input flow rate, an output flow rate, or the like) per unit time, information about the temperature of molten resin, and information about the pressure of molten resin, which are obtained from a flow rate sensor (not shown). The pressure of molten resin can also be identified based on the amount of molten resin in the coupling device 10 that is specified from the amount of molten resin input to the coupling device 10 and the amount of molten resin output from the coupling device 10.

Specifically, for example, in a case where the content of the information detected at each of the connecting member 31 and the connecting member 32 indicates an abnormality (an abnormality in pressure or temperature), the injection molding machine 90 may perform control to increase a flow rate at which molten resin is output from the coupling device 10 and input to the injection molding machine 90 so that the internal pressure of the coupling device 10 is lowered and the internal pressure of each of the swivel joints 21 to 23 is lowered. In addition, for example, in a case where the content of the information detected at each of the connecting member 31 and the connecting member 32 does not indicate an abnormality but indicates that there will be an abnormality in a case where there is no change although the degree of urgency is low, the injection molding machine 90 may increase a flow rate at which molten resin is output from the coupling device 10 and input to the injection molding machine 90 so that the internal pressure of the coupling device 10 is lowered and the internal pressure of each of the swivel joints 21 to 23 is lowered.

For example, the injection molding machine 90 may control, based on information detected at each of a molten resin inlet and a molten resin outlet of each of the swivel joints 21 to 23, the inputting of molten resin output from the coupling device 10 such that the internal pressure of the coupling device 10 is lowered and the internal pressure of each of the swivel joints 21 to 23 is lowered. Here, examples of the information detected at each of the molten resin inlet and the molten resin outlet of each of the swivel joints 21 to 23 include information about a molten resin flow rate per unit time, which is obtained from a flow rate sensor (not shown).

For example, the injection molding machine 90 performs, as control of the inputting of molten resin output from the coupling device 10, control for increasing a flow rate at which molten resin is input to the inlet 911. In this case, for example, the injection molding machine 90 controls the operation of the screw 912 or the plunger 922 that is disposed downstream of the inlet 911 and that is used for transportation or the like of molten resin such that a free space is formed on a downstream side and the molten resin enters the space. A flow rate at which molten resin is input to the inlet 911 can be increased in this manner. Therefore, the internal pressure of the coupling device 10 can be lowered, and the internal pressure of each of the swivel joints 21 to 23 can be lowered.

In addition, in the case of a configuration in which the injection molding machine 90 can control a gear pump (not shown) disposed in the decontamination machine 80, the injection molding machine 90 can lower the internal pressure of the coupling device 10 and lower the internal pressure of each of the swivel joints 21 to 23 by reducing the amount of molten resin output from the outlet 801 of the decontamination machine 80.

### Positional Relationship between Swivel Joints

FIG. 3 is a view showing a change in positional relationship between the swivel joints 21 to 23.

FIG. 3 shows how the positional relationship changes when the above-described swivel joints 21 to 23 shown in FIG. 2 are seen in a direction from the upper side to the lower side in the vertical direction. The positional relationship between the swivel joints 21 to 23 represented by solid lines is an example of a positional relationship at the time of normal operation of the injection molding machine 90 (refer to FIG. 2). However, the positional relationship between the swivel joint 21 represented by a solid line and the swivel joints 22 and 23 represented by broken lines is an example of a positional relationship at the time of positional movement of the plasticizing cylinder 91 of the injection molding machine 90. Note that as described above, it is assumed that the position of the outlet 801 (refer to FIG. 1) of the decontamination machine 80 is fixed. Therefore, it will be assumed that the position of the swivel joint 21 is also fixed.

Regarding the positional relationship between the swivel joints 21 to 23 at the time of normal operation of the injection molding machine 90, as shown in FIG. 3, the rotary shaft 402 of the swivel joint 22 represented by the solid line is disposed at a position offset from a virtual straight line 700 connecting the rotary shaft 401 of the swivel joint 21 and the rotary shaft 403 of the swivel joint 23 represented by the solid line to each other, the rotary shaft 402 being on a rear side in a front-rear direction with respect to the virtual straight line 700.

Here, the position of the swivel joint 23 represented by the solid line is a position closest to the second side in the coupling direction in an area in which the swivel joint 23 is movable. However, even at such a position, the rotary shaft 402 of the swivel joint 22 is not disposed on the virtual straight line 700. Specifically, the coupling device 10 is configured such that the sum of the length of a virtual straight line 701 connecting the rotary shaft 401 of the swivel joint 21 and the rotary shaft 402 of the swivel joint 22 to each other and the length of a virtual straight line 702 connecting the rotary shaft 402 of the swivel joint 22 and the rotary shaft 403 of the swivel joint 23 to each other is larger than the length of the virtual straight line 700.

The length of the virtual straight line 700 is specified based on a condition such as the installation position of the injection molding machine 90 or an area in which the position of the plasticizing cylinder 91 is movable. In addition, the length of the virtual straight line 701 is specified based on a condition such as the shape or length of the tube 12 (refer to FIG. 1). In addition, the length of the virtual straight line 702 is specified based on a condition such as the shape or length of the tube 13 (refer to FIG. 1). The coupling device 10 is designed in consideration of the above-described conditions such that the sum of the length of the virtual straight line 701 and the length of the virtual straight line 702 is larger than the length of the virtual straight line 700.

That is, when the position of the plasticizing cylinder 91 of the injection molding machine 90 is moved, the coupling device 10 repeats an operation of expanding in the coupling direction (an operation of being pulled to the second side) and an operation of contracting in the coupling direction (an operation of being pushed to the first side) in accordance with the movement. When these operations are seen in the direction from the upper side to the lower side in the vertical direction, the rotary shaft 402 of the swivel joint 22 rotates clockwise during an operation in which the coupling device 10 expands in the coupling direction, and rotates counterclockwise during an operation in which the coupling device 10 contracts in the coupling direction as shown in FIG. 3, for example.

Here, it will be assumed that the coupling device 10 has a configuration in which the coupling device 10 is linear in the coupling direction (a configuration in which the virtual straight lines 701 and 702 form one straight line as seen in the vertical direction). In this case, when the rotary shaft 403 of the swivel joint 23 is caused to move toward the first side, any one of a force that rotates the rotary shaft 402 of the swivel joint 22 counterclockwise and a force that rotates the rotary shaft 402 clockwise is applied. As a result, the rotary shaft 402 of the swivel joint 22 enters an unpredictable state in which the rotary shaft 402 rotates either counterclockwise or clockwise, which makes the trajectory of the pipe unstable. Note that it is also conceivable to provide a stopper that prevents clockwise rotation of the rotary shaft 402 in a configuration in which the virtual straight lines 701 and 702 form one straight line as seen in the vertical direction. However, in this case, a load is applied to the stopper, the rotary shaft, the pipe, and the like. Therefore, it is preferable that the coupling device 10 is configured such that the virtual straight lines 701 and 702 do not form one straight line as seen in the vertical direction even when the decontamination machine 80 and the injection molding machine 90 are relatively moved.

For such a configuration, for example, it is conceivable to provide a movement control upper limit of the amount of movement of the position of the plasticizing cylinder 91 or to determine the component dimensions of the injection molding machine 90 such that the sum of the length of the virtual straight line 701 and the length of the virtual straight line 702 is always larger than the length of the virtual straight line 700 when the position of the rotary shaft 403 of the swivel joint 23 is moved in the coupling direction. Specifically, for example, the movement control upper limit may be provided or the component dimensions may be determined such that the sum of the length of the virtual straight line 701 and the length of the virtual straight line 702 is always larger than the length of the virtual straight line 700 when the plasticizing cylinder 91 is brought as close to the second side in the coupling direction as possible.

In addition, for example, a member serving as a stopper may be provided so that the rotary shaft 402 of the swivel joint 22 is prevented from being disposed on the virtual straight line 700. In addition, as a process for preventing the rotary shaft 402 of the swivel joint 22 from being disposed on the virtual straight line 700, a process of detecting the position of the rotary shaft 402 of the swivel joint 22 and outputting a warning message, a warning voice, or the like or stopping the operation of the system when the rotary shaft 402 of the swivel joint 22 is brought close to the virtual straight line 700 may also be adopted.

Furthermore, in a case where the rotary shaft 402 of the swivel joint 22 is disposed on the virtual straight line 700, when the swivel joint 23 moves toward the first side in the coupling direction, a force (an unbalanced load) that moves the swivel joint 22 toward the first side in the coupling direction may be applied instead of a force that moves the swivel joint 22 in the front-rear direction. Therefore, a relationship between the length of the virtual straight line 700, the length of the virtual straight line 701, and the length of the virtual straight line 702 is considered so that the rotary shaft 402 of the swivel joint 22 is prevented from being disposed on the virtual straight line 700.

When the position of the plasticizing cylinder 91 (refer to FIGS. 1 and 2) of the injection molding machine 90 is moved to the first side in the coupling direction, the connecting member 32 (refer to FIG. 1) and the swivel joint 23 move toward the first side in the coupling direction in accordance with the positional movement of the plasticizing cylinder 91. Specifically, as shown in FIG. 3, the swivel joint 23 represented by the solid line moves in a direction along an arrow to reach the position of the swivel joint 23 represented by the broken line. In this case, the swivel joint 22 moves counterclockwise in a circumferential direction around the swivel joint 21. Specifically, as shown in FIG. 3, the swivel joint 22 represented by the solid line moves in a direction along an arrow to reach the position of the swivel joint 22 represented by the broken line.

Accordingly, the virtual straight line 701 is moved to the position of the virtual straight line 703, and the virtual straight line 702 is moved to the position of a virtual straight line 704. In addition, a large circle shown by a broken line in FIG. 3 represents the circumferential direction around the swivel joint 21, and does not represent an area in which the swivel joint 22 is movable. The area in which the swivel joint 22 is movable is determined by the area in which the swivel joint 23 is movable, a distance between the swivel joint 21 and the swivel joint 22, a distance between the swivel joint 22 and the swivel joint 23, and the like.

In conclusion, the coupling device according to the first embodiment of the present invention only needs to have a configuration as follows, and various embodiments can be adopted.

That is, the coupling device 10 according to the first embodiment is a coupling device that couples the decontamination machine 80 outputting molten resin to be recycled from an outlet to the injection molding machine 90 including the plasticizing cylinder 91 that includes the inlet 911 through which the output molten resin is input and that heats the molten resin and the injection cylinder 92 that is independent of the plasticizing cylinder 91 and that injects the heated molten resin into the mold 93, the coupling device coupling the decontamination machine 80 to the injection molding machine 90 with one end of a pipe formed by the tubes 11 to 14 and the swivel joints 21 to 23 through which the molten resin passes being connected to the outlet 801 via the connecting member 31 and the other end of the pipe being connected to the inlet 911 via the connecting member 32.

Accordingly, the one end of the pipe formed by the tubes 11 to 14 and the swivel joints 21 to 23 through which the molten resin passes is connected to the outlet 801 of the decontamination machine 80 via the connecting member 31, and the other end of the pipe is connected to the inlet 911 of the injection molding machine 90 via the connecting member 32, and thus the decontamination machine 80 and the injection molding machine 90 are coupled to each other. In a case where the swivel joints 21 to 23 are adopted as couplings for a tube through which the molten resin passes as above, a sleeve does not slide to enter and exit the pipe as in a case where a sleeve is provided as a coupling. Therefore, leakage of molten resin passing through the pipe from a coupling is suppressed.

Here, the number of swivel joints provided for the coupling device 10 may be three.

Accordingly, since the number of swivel joints that are provided for the coupling device 10 and that serve as couplings of the pipe is three (for example, the swivel joints 21 to 23), the trajectory of the pipe is flexibly changed with respect to positional movement of the plasticizing cylinder 91 of the injection molding machine 90 in comparison with a case where the number of swivel joints is one or two. In addition, the trajectory of the pipe can be made stable, and various costs (procurement cost, maintenance cost, adjustment cost, and the like for swivel joints) can be further reduced in comparison with a case where the number of swivel joints is four or more.

In addition, the swivel joints 21 to 23 may include seal members, each having a predetermined heat-proof temperature and a predetermined proof pressure.

In this case, each of the seal members of the swivel joints 21 to 23 has the predetermined heat-proof temperature and the predetermined proof pressure. The heat-proof temperature and the proof pressure of the seal members are determined by the physical properties of resin to be recycled and the pressure (for example, the amount of molten resin or the like) in the coupling device 10. For example, a temperature and a pressure at which resin to be recycled can be transported in a molten state are determined as the heat-proof temperature and the proof pressure. In a case where the heat-proof temperature and the proof pressure of the seal members are in a trade-off relationship, the heat-proof temperature of the seal members is increased when the internal pressure of the swivel joints is lowered. As a result, deterioration of the seal member of each of the swivel joints 21 to 23 can be suppressed.

In addition, the coupling device 10 may heat the molten resin passing through the pipe by heating the pipe formed by the tubes 11 to 14 and the swivel joints 21 to 23 through which the molten resin passes.

Accordingly, the coupling device 10 heats the molten resin passing through the pipe by heating the pipe. A heating temperature is preferably a temperature matching the temperature of the resin to be recycled passing through the inside of the pipe, more preferably a temperature higher than the melting point of the resin to be recycled passing through the inside of the pipe and lower than the heat-proof temperature of the seal members of the swivel joints 21 to 23. Note that heating the pipe includes heating the pipe for performing temperature control such that the temperature of the pipe is maintained within a predetermined range. As a result, the molten resin output from the decontamination machine 80 is made less likely to be cooled and solidified before the molten resin is input to the injection molding machine 90. In addition, since the molten resin of which the temperature is maintained at a high temperature is input to the plasticizing cylinder 91, power saving can be achieved at the time of heating performed by the plasticizing cylinder 91.

In addition, the coupling device 10 may heat the pipe by means of a band heater.

The band heater is a lightweight and thin cylindrical heater and can be mounted while being brought into close contact with a cylindrical pipe through a simple operation since an inner surface of the band heater that comes into contact with the pipe is smooth. As a result, the pipe can be efficiently heated.

In addition, the swivel joints 21 to 23 may enable rotation of the tubes 12 and 13 by means of sliding bearings, and a portion of the molten resin may be used as a lubricant for the sliding bearings.

Accordingly, in a case where the swivel joints 21 to 23 enable rotation of the tubes by means of the sliding bearings, a portion of the molten resin passing through the swivel joints 21 to 23 is used as the lubricant. As a result, it is not necessary to separately prepare a lubricant, and it is possible to make the molten resin less likely to be mixed with a separately prepared lubricant.

In addition, the molten resin supply system according to the first embodiment of the present invention only needs to have a configuration as follows, and various embodiments can be adopted.

That is, the molten resin supply system 1 according to the first embodiment is a molten resin supply system that includes the decontamination machine 80, the injection molding machine 90, and the coupling device 10, the position of the outlet 801 of the decontamination machine 80 is fixed, and the position of the inlet 911 of the plasticizing cylinder 91 is moved in accordance with positional movement of the plasticizing cylinder 91.

Accordingly, even in a case where the position of the outlet 801 of the decontamination machine 80 is fixed and the position of the inlet 911 of the plasticizing cylinder 91 is moved, the trajectory of the pipe is flexibly changed due to the swivel joints 21 to 23 serving as couplings. As a result, leakage of molten resin passing through a pipe from a coupling is suppressed in comparison with a case where a sleeve that serves as a coupling of the pipe connecting the decontamination machine and the injection molding machine to each other is provided.

In addition, the molten resin supply system 1 is a molten resin supply system that includes the decontamination machine 80, the injection molding machine 90, and the coupling device 10, and the virtual straight lines 701 and 702 that connect the respective rotary shafts 401 to 403 of the three swivel joints 21 to 23 to each other do not form one straight line as seen in the vertical direction even when the decontamination machine 80 and the injection molding machine 90 are relatively moved or a process of preventing the virtual straight lines 701 and 702 from forming one straight line as seen in the vertical direction is performed, the three swivel joints 21 to 23 being coupled to each other via the two tubes 12 and 13 of the coupling device 10.

Accordingly, the virtual straight lines 701 and 702 that connect the respective rotary shafts 401 to 403 of the three swivel joints 21 to 23 to each other can be prevented from forming one straight line as seen in the vertical direction, the three swivel joints 21 to 23 being coupled to each other via the two tubes 12 and 13. As a result, the trajectory of the pipe can be made stable in comparison with a case where the virtual straight lines 701 and 702 that connect the respective rotary shafts 401 to 403 of the three swivel joints 21 to 23 to each other form one straight line as seen in the vertical direction.

Here, the decontamination machine 80 or the injection molding machine 90 may perform control for reducing the internal pressure of each of the swivel joints 21 to 23 depending on the internal pressure of each of the swivel joints 21 to 23.

For example, the decontamination machine 80 can reduce, based on information detected at each of the connecting member 31 and the connecting member 32 or information detected at each of the molten resin inlet and the molten resin outlet of each of the swivel joints 21 to 23, the amount of molten resin output to the coupling device 10 such that the internal pressure of the coupling device 10 is lowered and the internal pressure of each of the swivel joints 21 to 23 is lowered. The decontamination machine 80 can reduce, based on the amount of molten resin used in the injection molding machine 90 or the amount of molten resin discharged from the injection molding machine 90, the amount of molten resin output to the coupling device 10 such that the internal pressure of the coupling device 10 is lowered and the internal pressure of each of the swivel joints 21 to 23 is lowered. In addition, the injection molding machine 90 may increase, based on information detected at each of the connecting member 31 and the connecting member 32 or information detected at each of the molten resin inlet and the molten resin outlet of each of the swivel joints 21 to 23, the amount of molten resin input after being output from the coupling device 10 such that the internal pressure of the coupling device 10 is lowered and the internal pressure of each of the swivel joints 21 to 23 is lowered. Accordingly, in a case where the heat-proof temperature and the proof pressure of seal members (not shown) of the swivel joints 21 to 23 are in a trade-off relationship, the proof pressure of the seal members can be lowered so that the heat-proof temperature is increased, which can result in suppression of deterioration of the seal members.

In addition, the decontamination machine 80 or the injection molding machine 90 may perform, as the control for reducing the internal pressure of each of the swivel joints 21 to 23, control for lowering a pressure at which the molten resin is output from the outlet 801 of the decontamination machine 80.

Accordingly, as the control for reducing the internal pressure of the swivel joints 21 to 23, control for lowering a pressure at which the molten resin is output from the outlet 801 of the decontamination machine 80 is performed. As a result, in a case where the heat-proof temperature and the proof pressure of the seal members of the swivel joints 21 to 23 are in a trade-off relationship, the proof pressure of the seal members can be lowered so that the heat-proof temperature is increased, which can result in suppression of deterioration of the seal members.

In addition, the decontamination machine 80 or the injection molding machine 90 may perform, as the control for lowering a pressure at which the molten resin is output from the outlet 801, control of at least one of the outputting of the molten resin from the decontamination machine 80 and the inputting of molten resin to the injection molding machine 90.

Accordingly, the outputting of the molten resin from the decontamination machine 80 is controlled, or the inputting of molten resin to the injection molding machine 90 is controlled. As a result, the internal pressure of the coupling device 10 can be lowered, and the internal pressure of each of the swivel joints 21 to 23 can be lowered. Therefore, for example, in a case where the heat-proof temperature and the proof pressure of the seal members of the swivel joints 21 to 23 are in a trade-off relationship, the proof pressure of the seal members can be lowered so that the heat-proof temperature is increased, which can result in suppression of deterioration of the seal members.

In addition, the decontamination machine 80 or the injection molding machine 90 may calculate the internal pressure of each of the swivel joints 21 to 23 based on information detected at each of a molten resin inlet and a molten resin outlet of each of the swivel joints 21 to 23.

Accordingly, the internal pressure of the swivel joints is calculated based on information about molten resin detected at each of the molten resin inlet and the molten resin outlet of each of the swivel joints 21 to 23. As a result, it is possible to control the internal pressure of each of the swivel joints 21 to 23 based on a value obtained through the calculation.

In addition, the position of the outlet 801 of the decontamination machine 80 in the vertical direction and the position of the inlet 911 of the injection molding machine 90 in the vertical direction may be on approximately the same horizontal straight line.

Accordingly, since the position of the outlet 801 of the decontamination machine 80 in the vertical direction and the position of the inlet 911 of the injection molding machine 90 in the vertical direction are on approximately the same horizontal straight line, generation of thermal stress accompanied by thermal expansion of the pipe can be suppressed. As a result, damage or the like to the pipe accompanied by generation of thermal stress can be suppressed in comparison with a case where the position of the outlet of the decontamination machine in the vertical direction and the position of the inlet of the injection molding machine in the vertical direction are not on approximately the same horizontal straight line (for example, a coupling device 20 according to a second embodiment which will be described later). Note that a relationship between the position of the outlet 801 of the decontamination machine 80 in the vertical direction and the position of the inlet 911 of the injection molding machine 90 in the vertical direction will be described in comparison between the first embodiment and the second embodiment which will be described later with reference to FIG. 4.

### Second Embodiment

### Configuration of Molten Resin Supply System

FIG. 4 is a front view showing a part of an external appearance configuration of a molten resin supply system 2 according to the second embodiment.

The configuration of the molten resin supply system 2 according to the second embodiment is essentially the same as the configuration of the molten resin supply system 1 according to the first embodiment described above. However, as shown in FIGS. 1 and 4, the position of the outlet 801 of the decontamination machine 80 in the vertical direction in the first embodiment and the position of an outlet 811 of a decontamination machine 81 in the vertical direction in the second embodiment are different from each other. Therefore, the shape of the pipe of the coupling device 20 according to the second embodiment and the shape of the pipe of the coupling device 10 according to the first embodiment are different from each other.

The configuration of the coupling device 20 according to the second embodiment is as follows. That is, as shown in FIG. 4, the coupling device 20 is a device composed of a pipe that couples the decontamination machine 81 disposed on the first side in the coupling direction and the injection molding machine 90 disposed on the second side to each other. The coupling device 20 is composed of tubes 41 to 44, swivel joints 51 to 53, and connecting members 61 and 62, and is a meandering pipe obtained by coupling the tubes 41 to 44, the swivel joints 51 to 53, and the connecting members 61 and 62 to each other.

The tubes 41 to 44 are metal tubes through which molten resin passes. Among these, the tube 41 is a tube of which one end is connected to the connecting member 61 and of which the other end is connected to the swivel joint 51. The tube 41 has a curved shape that causes molten resin flowing from the first side to the second side in the coupling direction to flow to the lower side in the vertical direction. The tube 42 is a tube of which one end is connected to the swivel joint 51 and of which the other end is connected to the swivel joint 52. The tube 42 has a curved shape that causes molten resin flowing from the upper side to the lower side in the vertical direction to flow to the second side in the coupling direction and the upper side in the vertical direction in this order.

The tube 43 is a tube of which one end is connected to the swivel joint 52 and of which the other end is connected to the swivel joint 53. The tube 43 has a curved shape that causes molten resin flowing from the lower side to the upper side in the vertical direction to flow to the second side in the coupling direction and the lower side in the vertical direction in this order. The tube 44 is a tube of which one end is connected to the swivel joint 53 and of which the other end is connected to the connecting member 62. The tube 44 has a linear shape that causes molten resin flowing from the upper side to the lower side in the vertical direction to flow to the lower side as it is.

The swivel joint 51 is a swivel joint of which an end portion on the upper side in the vertical direction is connected to the tube 41 and of which an end portion on the lower side is connected to the tube 42. A rotary shaft 71 of the swivel joint 51 enables rotation of the tubes 41 and 42. The swivel joint 52 is a swivel joint of which an end portion on the lower side in the vertical direction is connected to the tube 42 and of which an end portion on the upper side is connected to the tube 43. A rotary shaft 72 of the swivel joint 52 enables rotation of the tubes 42 and 43. In addition, in accordance with a positional change of the swivel joint 53 (which will be described later) in the coupling direction, the position of the swivel joint 52 is changed in a circumferential direction around the rotary shaft 71 of the swivel joint 51 and a circumferential direction around a rotary shaft 73 of the swivel joint 53 of which the position is changed. Note that the positional change of the swivel joint 52 is similar to the positional change of the swivel joint 22 in FIG. 3 described above.

The swivel joint 53 is a swivel joint of which an end portion on the upper side in the vertical direction is connected to the tube 43 and of which an end portion on the lower side is connected to the tube 44. The rotary shaft 73 of the swivel joint 53 enables rotation of the tubes 43 and 44. In addition, when the position of the plasticizing cylinder 91 of the injection molding machine 90 is moved, the position of the swivel joint 53 changes in accordance with the movement. Note that the positional change of the swivel joint 53 is similar to the positional change of the swivel joint 23 in FIG. 3 described above.

The connecting member 61 is a member for connecting the coupling device 20 to the decontamination machine 81, and is fixed to the decontamination machine 81 by a flange or the like. Specifically, an end portion of the connecting member 61 that is on the first side in the coupling direction is connected to the outlet 811 of the decontamination machine 81, and an end portion of the connecting member 61 that is on the second side in the coupling direction is connected to the tube 41. The connecting member 62 is a member for connecting the coupling device 20 to the injection molding machine 90, and is fixed to the injection molding machine 90 by a flange or the like. Specifically, an end portion of the connecting member 62 that is on the upper side in the vertical direction is connected to the tube 44, and an end portion of the connecting member 62 that is on the lower side in the vertical direction is connected to the inlet 911 provided in the plasticizing cylinder 91 of the injection molding machine 90.

### Comparison between First Embodiment and Second Embodiment

In the case of the coupling device 20 according to the second embodiment, as with the coupling device 10 according to the first embodiment, leakage of molten resin passing through a pipe from a coupling is suppressed in comparison with a case where a sleeve that serves as a coupling of the pipe connecting the decontamination machine and the injection molding machine to each other is provided. However, the coupling device 10 (refer to FIG. 1) according to the first embodiment and the coupling device 20 (refer to FIG. 4) according to the second embodiment are different from each other in the following points, for example.

That is, as shown in FIG. 1, the position of the outlet 801 of the decontamination machine 80, which is coupled to the coupling device 10 according to the first embodiment, in the vertical direction is on approximately the same horizontal straight line as the position of the inlet 911 of the injection molding machine 90 in the vertical direction. However, as shown in FIG. 4, the position of the outlet 811 of the decontamination machine 81, which is coupled to the coupling device 20 according to the second embodiment, in the vertical direction is not on approximately the same horizontal straight line as the position of the inlet 911 of the injection molding machine 90 in the vertical direction.

Since the position of the outlet 801 of the decontamination machine 80, which is coupled to the coupling device 10 according to the first embodiment shown in FIG. 1, in the vertical direction and the position of the inlet 911 of the injection molding machine 90 in the vertical direction are on approximately the same horizontal straight line, generation of thermal stress on the coupling device 10 is suppressed even in a case where there is thermal expansion when the pipe of the coupling device 10 is heated by the band heater or the like. Accordingly, damage or the like to the tubes 11 to 14 constituting the pipe or the bearings of the swivel joints 21 to 23 is suppressed.

In addition, in the coupling device 10 according to the first embodiment shown in FIG. 1, the four paths that form the pipe and that extend in the vertical direction are on the same side (the upper side) in the vertical direction with respect to the outlet 801 and the inlet 911. Therefore, the directions of expansion at the time of thermal expansion of the pipe can be made equal to each other, so that generation of thermal stress on the coupling device 10 is further suppressed. Specifically, at a portion of the coupling device 10 that is on the first side in the coupling direction, thermal expansion occurs in a direction from the lower side to the upper side in the vertical direction, and at a portion of the coupling device 10 that is on the second side in the coupling direction, thermal expansion occurs in the direction from the lower side to the upper side in the vertical direction to the same degree as the first side. In this case, generation of thermal stress on the coupling device 10 is further suppressed, and thus damage or the like to the tubes 11 to 14 constituting the pipe or the bearings of the swivel joints 21 to 23 is further suppressed.

However, the position of the outlet 811 of the decontamination machine 81, which is coupled to the coupling device 20 according to the second embodiment shown in FIG. 4, in the vertical direction and the position of the inlet 911 of the injection molding machine 90 in the vertical direction are not on approximately the same horizontal straight line, and thus thermal stress on the coupling device 20 is likely to be generated. In addition, in the coupling device 20 according to the second embodiment shown in FIG. 4, three paths that form the pipe and that extend in the vertical direction are not on the same side in the vertical direction with respect to the outlet 811 and the inlet 911. That is, the three paths are on the lower side in the vertical direction with respect to the outlet 811 and are on the upper side in the vertical direction with respect to the inlet 911. Therefore, the directions of expansion at the time of thermal expansion of the pipe that occurs when the pipe of the coupling device 20 is heated cannot be made equal to each other. Specifically, at a portion of the coupling device 20 that is on the first side in the coupling direction, thermal expansion occurs in a direction from the upper side to the lower side in the vertical direction, and at a portion of the coupling device 20 that is on the second side in the coupling direction, thermal expansion occurs in the direction from the lower side to the upper side in the vertical direction to the same degree as the first side.

In this case, thermal stress on the coupling device 20 may be generated, and thus damage or the like to the tubes 41 to 44 constituting the pipe, the shaft portions, the bearings, the seal members, and the like of the swivel joints 51 to 53 may occur, which may result in leakage of molten resin flowing inside the coupling device 20. Therefore, the configuration of the coupling device 10 according to the first embodiment, that is, a configuration in which the position of the outlet 801 of the decontamination machine 80 in the vertical direction and the position of the inlet 911 of the injection molding machine 90 in the vertical direction are on approximately the same horizontal straight line, is preferable in comparison with the configuration of the coupling device 20 according to the second embodiment, and a configuration in which the directions of expansion at the time of thermal expansion of the pipe that occurs when the pipe is heated are equal to each other is more preferable than a configuration in which the directions of expansion at the time of thermal expansion of the pipe that occurs when the pipe is heated are opposite to each other. In conclusion, it can be said that the coupling device 20 according to the second embodiment has a configuration that can be selected in a case where there are restrictions on the positional relationship between the decontamination machine 81 and the injection molding machine 90, the position of the outlet 811 of the decontamination machine 81, and the position of the inlet 911 of the injection molding machine 90, and the position of the outlet 811 of the decontamination machine 81 in the vertical direction and the position of the inlet 911 of the injection molding machine 90 in the vertical direction cannot be disposed on approximately the same horizontal straight line.

In addition, a configuration in which the directions of expansion at the time of thermal expansion of the pipe that occurs when the pipe is heated are not equal to each other even though the position of the outlet 801 of the decontamination machine 80 in the vertical direction and the position of the inlet 911 of the injection molding machine 90 in the vertical direction are on approximately the same horizontal straight line as in the coupling device 10 according to the first embodiment shown in FIG. 1 is also conceivable. Such a configuration will be described as a third embodiment.

### Third Embodiment

### Configuration of Molten Resin Supply System

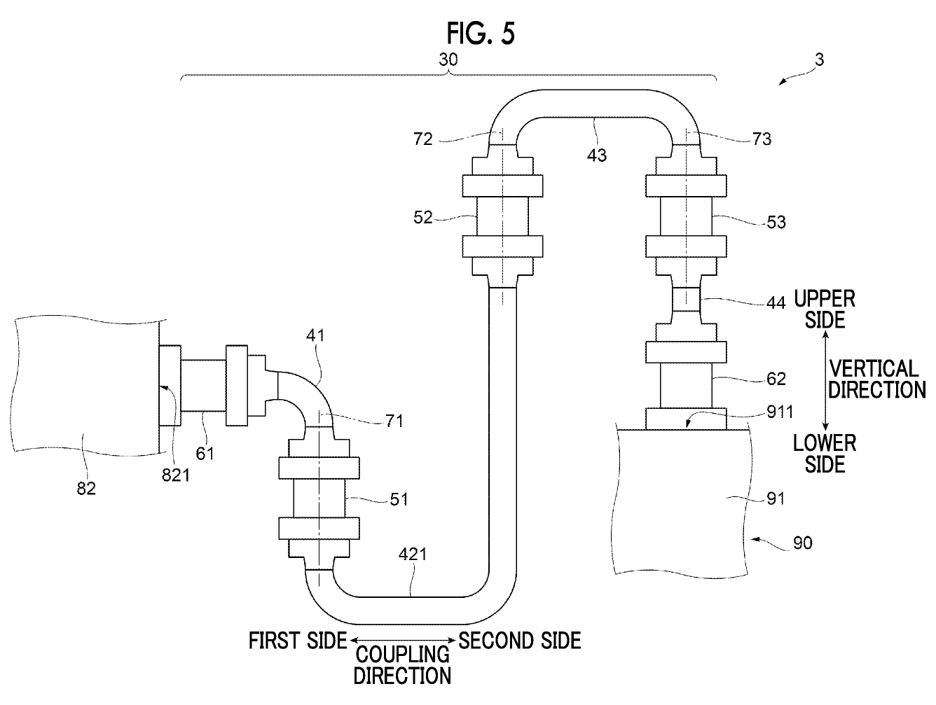

FIG. 5 is a front view showing a part of an external appearance configuration of a molten resin supply system 3 according to the third embodiment. As shown in FIGS. 4 and 5, the configuration of the molten resin supply system 3 according to the third embodiment is essentially the same as the configuration of the molten resin supply system 2 according to the second embodiment described above. However, the position of the outlet 811 of the decontamination machine 81 according to the second embodiment in the vertical direction and the position of an outlet 821 of a decontamination machine 82 according to the third embodiment in the vertical direction are different from each other. Therefore, the shape of the tube 42 of the coupling device 20 according to the second embodiment and the shape of a tube 421 of a coupling device 30 according to the third embodiment are different from each other.

The configuration of the coupling device 30 according to the third embodiment is as follows. That is, as shown in FIG. 5, the coupling device 30 is a device composed of a pipe that couples the decontamination machine 82 disposed on the first side in the coupling direction and the injection molding machine 90 disposed on the second side to each other. The coupling device 30 is composed of the tube 41, the tube 421, the tube 43, the tube 44, the swivel joints 51 to 53, and the connecting members 61 and 62, and is a meandering pipe obtained by coupling the tube 41, the tube 421, the tube 43, the tube 44, the swivel joints 51 to 53, and the connecting members 61 and 62 to each other.

The tube 421 is a metal tube through which molten resin passes, of which one end is connected to the swivel joint 51, and of which the other end is connected to the swivel joint 52. The tube 421 has a curved shape that causes molten resin flowing from the upper side to the lower side in the vertical direction to flow to the second side in the coupling direction and the upper side in the vertical direction in this order and has a shape of which a portion extending in the vertical direction is particularly long. Note that the configurations of the tube 41, the tube 43, the tube 44, the swivel joints 51 to 53, and the connecting members 61 and 62 are the same as the configurations of the tube 41, the tube 43, the tube 44, the swivel joints 51 to 53, and the connecting members 61 and 62 in the coupling device 20 according to the second embodiment shown in FIG. 4 described above. Therefore, the description thereof will be omitted.

### Comparison between Second Embodiment and Third Embodiment

As shown in FIGS. 4 and 5, in the case of the coupling device 30 according to the third embodiment, the position of the outlet 821 of the decontamination machine 82 in the vertical direction is on approximately the same horizontal straight line as the position of the inlet 911 of the injection molding machine 90 in the vertical direction unlike the coupling device 20 according to the second embodiment. Therefore, when the pipe of the coupling device 30 is heated, a portion of the coupling device 30 that is closer to the upper side than the positions of the outlet 821 and the inlet 911 in the vertical direction are thermally expands to expand to the upper side, and a portion of the coupling device 30 that is closer to the lower side than the positions of the outlet 821 and the inlet 911 in the vertical direction are thermally expands to expand to the lower side. In this case, a difference between the degree of thermal expansion toward the upper side and the degree of thermal expansion toward the lower side is not enough to cause generation of thermal stress on the coupling device 30 and damage or the like to each portion of the pipe. However, in the case of the coupling device 20 according to the second embodiment, as shown in FIG. 4, the position of the outlet 811 of the decontamination machine 81 in the vertical direction is not on approximately the same horizontal straight line as the position of the inlet 911 of the injection molding machine 90 in the vertical direction, so that thermal stress on the coupling device 20 is likely to be generated. Therefore, the configuration in the third embodiment is more preferable than the configuration in the second embodiment.

### Comparison between First Embodiment and Third Embodiment

As shown in FIGS. 1 and 5, in the case of the coupling device 30 according to the third embodiment, the position of the outlet 821 of the decontamination machine 82 in the vertical direction is on approximately the same horizontal straight line as the position of the inlet 911 of the injection molding machine 90 in the vertical direction as with the coupling device 10 according to the first embodiment. However, in the coupling device 30 according to the third embodiment, three paths that form the pipe and that extend in the vertical direction are not on the same side in the vertical direction with respect to the positions of the outlet 821 and the inlet 911 in the vertical direction unlike the coupling device 10 according to the first embodiment. That is, some of the three paths are on the lower side with respect to the positions of the outlet 821 and the inlet 911 in the vertical direction, and some of the three paths are on the upper side with respect to the positions of the outlet 821 and the inlet 911 in the vertical direction. Therefore, in the case of the coupling device 30 according to the third embodiment, the directions of expansion at the time of thermal expansion of the pipe cannot be made equal to each other unlike the coupling device 10 according to the first embodiment.

Specifically, the pipe of the coupling device 30 is formed with a path (hereinafter, will be referred to as a “first path in the third embodiment”) that includes the swivel joint 51 and that extends in the vertical direction, a path (hereinafter, will be referred to as a “second path in the third embodiment”) that includes the swivel joint 52 and the tube 421 and that extends in the vertical direction, and a path (hereinafter, will be referred to as a “third path in the third embodiment”) that includes the swivel joint 53 and that extends in the vertical direction. Among these, the first path in the third embodiment is on the lower side with respect to the positions of the outlet 821 and the inlet 911 in the vertical direction as a whole, and a third path in the third embodiment is on the upper side with respect to the positions of the outlet 821 and the inlet 911 in the vertical direction as a whole. In addition, the second path in the third embodiment has a portion that is on the upper side with respect to the positions of the outlet 821 and the inlet 911 in the vertical direction and has a portion that is on the lower side with respect to the positions of the outlet 821 and the inlet 911 in the vertical direction.

Here, when the pipe of the coupling device 30 thermally expands, a portion of the coupling device 30 that is on the lower side with respect to the positions of the outlet 821 and the inlet 911 in the vertical direction thermally expands in a direction from the upper side to the lower side in the vertical direction. On the other hand, a portion of the coupling device 30 that is on the upper side with respect to the positions of the outlet 821 and the inlet 911 in the vertical direction thermally expands in a direction from the lower side to the upper side in the vertical direction. Here, a difference between the degree of thermal expansion of a portion of the pipe of the coupling device 30 that expands toward the upper side and the degree of thermal expansion of a portion of the pipe of the coupling device 30 that expands toward the lower side is not enough to cause generation of thermal stress on the pipe of the coupling device 30 and damage or the like to each portion as described above.

However, a portion with a swivel joint and a portion without a swivel joint may be different from each other in degree of expansion caused by thermal expansion. In this regard, regarding a portion of the pipe of the coupling device 30 that expands toward the upper side due to thermal expansion, an upper portion of the second path in the third embodiment is provided with the swivel joint 52, and the third path in the third embodiment is provided with the swivel joint 53. Therefore, there is a low probability of a difference in degree of expansion caused by thermal expansion. However, regarding a portion of the pipe of the coupling device 30 that expands toward the lower side due to thermal expansion, the first path in the third embodiment is provided with the swivel joint 51, but a lower portion of the second path in the third embodiment is not provided with a swivel joint. Therefore, there is a possibility of a difference in degree of expansion of the pipe at the time of thermal expansion. Hereinafter, such a difference will be referred to as an “an expansion and contraction difference”.

The expansion and contraction difference of the pipe due to the presence or absence of a swivel joint is one of the causes of generation of thermal stress on the coupling device 30, and a swivel joint or the pipe may be inclined when the expansion and contraction difference is large. The influence of the expansion and contraction difference due to the presence or absence of a swivel joint on generation of thermal stress is larger in a case where the directions of thermal expansion are not equal to each other than in a case where the directions of thermal expansion are equal to each other. In conclusion, the first embodiment in which the directions of thermal expansion are equal to each other is more preferable than the third embodiment in which the directions of thermal expansion are not equal to each other since the influence of the expansion and contraction difference is small.

As described above, the expansion and contraction difference of the pipe due to the presence or absence of a swivel joint is one of the causes of generation of thermal stress. However, the influence of the expansion and contraction difference of the pipe can be suppressed depending on the disposition of swivel joints. Such a configuration will be described as a fourth embodiment.

### Fourth Embodiment

### Configuration of Molten Resin Supply System

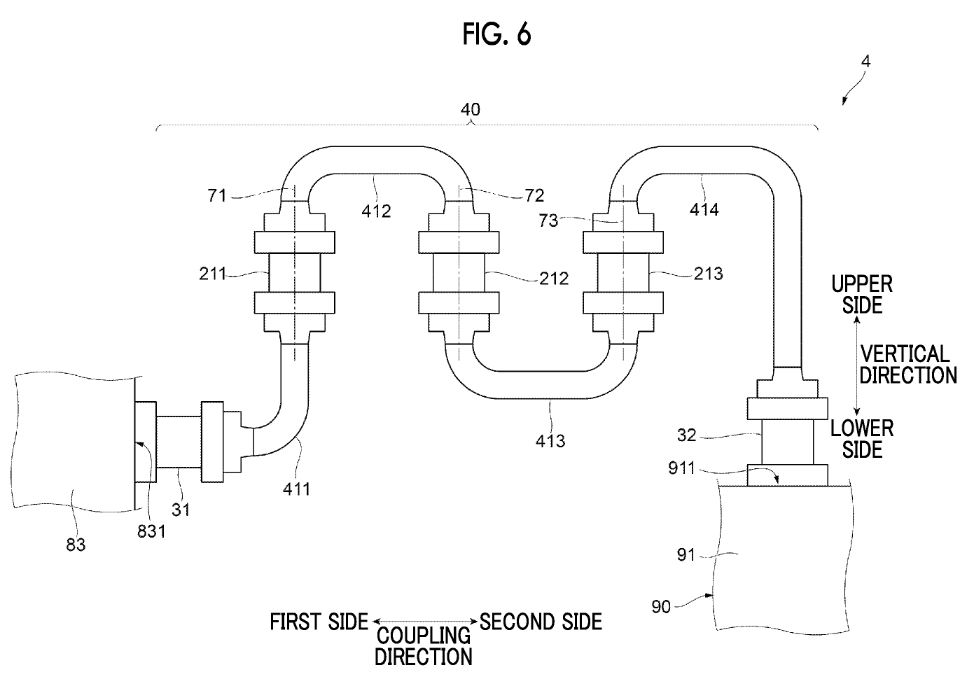

FIG. 6 is a front view showing a part of an external appearance configuration of a molten resin supply system 4 according to the fourth embodiment.

As shown in FIGS. 1 and 6, the configuration of the molten resin supply system 4 according to the fourth embodiment is essentially the same as the configuration of the molten resin supply system 1 according to the first embodiment described above. However, the configurations are different from each other in disposition of swivel joints.

The configuration of a coupling device 40 according to the fourth embodiment is as follows. That is, as shown in FIG. 6, the coupling device 40 is a device composed of a pipe that couples a decontamination machine 83 disposed on the first side in the coupling direction and the injection molding machine 90 disposed on the second side to each other. The coupling device 40 is composed of tubes 411 to 414, swivel joints 211 to 213, and the connecting members 31 and 32, and is a meandering pipe obtained by coupling the tubes 411 to 414, the swivel joints 211 to 213, and the connecting members 31 and 32 to each other.

The tube 411 is a tube of which one end is connected to the connecting member 31 and of which the other end is connected to the swivel joint 211 and has the same configuration as the tube 11 in FIG. 1. That is, the tube 411 has a curved shape that causes molten resin flowing from the first side to the second side in the coupling direction to flow to the upper side in the vertical direction. The tube 412 is a tube of which one end is connected to the swivel joint 211 and of which the other end is connected to the swivel joint 212. The tube 412 has a curved shape that causes molten resin flowing from the lower side to the upper side in the vertical direction to flow to the second side in the coupling direction and the lower side in the vertical direction in this order.

The tube 413 is a tube of which one end is connected to the swivel joint 212 and of which the other end is connected to the swivel joint 213. The tube 413 has a curved shape that causes molten resin flowing from the upper side to the lower side in the vertical direction to flow to the second side in the coupling direction and the upper side in the vertical direction in this order. The tube 414 is a tube of which one end is connected to the swivel joint 213 and of which the other end is connected to the connecting member 32. The tube 414 has a curved shape that causes molten resin flowing from the lower side to the upper side in the vertical direction to flow to the second side in the coupling direction and the lower side in the vertical direction in this order.

The swivel joint 211 is a swivel joint of which an end portion on the lower side in the vertical direction is connected to the tube 411 and of which an end portion on the upper side is connected to the tube 412. The swivel joint 212 is a swivel joint of which an end portion on the upper side in the vertical direction is connected to the tube 412 and of which an end portion on the lower side is connected to the tube 413. The swivel joint 213 is a swivel joint of which an end portion on the lower side in the vertical direction is connected to the tube 413 and of which an end portion on the upper side is connected to the tube 414. Note that the configuration of each of the connecting members 31 and 32 is the same as the configuration of each of the connecting members 31 and 32 in the coupling device 10 according to the first embodiment shown in FIG. 1 described above. Therefore, the description thereof will be omitted.

### Comparison between First Embodiment and Fourth Embodiment

As shown in FIGS. 1 and 6, in the case of the coupling device 40 according to the fourth embodiment, the position of an outlet 831 of the decontamination machine 83 in the vertical direction is on approximately the same horizontal straight line as the position of the inlet 911 of the injection molding machine 90 in the vertical direction as with the coupling device 10 according to the first embodiment. In addition, in the coupling device 40 according to the fourth embodiment, four paths that form the pipe and that extend in the vertical direction are on the same side (the upper side) with respect to the positions of the outlet 831 and the inlet 911 in the vertical direction as with the coupling device 10 according to the first embodiment. Therefore, the directions of expansion at the time of thermal expansion of the pipe are equal to each other.

In addition, there is an expansion and contraction difference due to the presence or absence of a swivel joint in both of the pipe of the coupling device 10 according to the first embodiment and the pipe of the coupling device 40 according to the fourth embodiment. Specifically, as shown in FIG. 1, the pipe of the coupling device 10 according to the first embodiment is formed with a path (hereinafter, will be referred to as a “first path in the first embodiment”) that includes the swivel joint 21 and that extends in the vertical direction, a path (hereinafter, will be referred to as a “second path in the first embodiment”) that is composed of the tube 12 and that extends in the vertical direction, a path (hereinafter, will be referred to as a “third path in the first embodiment”) that includes the swivel joint 22 and that extends in the vertical direction, and a path (hereinafter, will be referred to as a “fourth path in the first embodiment”) that includes the swivel joint 23 and that extends in the vertical direction.

The first path, the third path, and the fourth path in the first embodiment are respectively provided with the swivel joints 21 to 23. However, the second path in the first embodiment is not provided with a swivel joint. Therefore, at the time of thermal expansion of the pipe, there is an expansion and contraction difference between the first path and the second path in the first embodiment. In addition, there may be an expansion and contraction difference between the second path and the third path in the first embodiment. However, a probability of an expansion and contraction difference between the third path and the fourth path in the first embodiment is low. That is, when the pipe of the coupling device 10 according to the first embodiment thermally expands, thermal stress may be generated, and thus each of the swivel joints 21 and 22 respectively disposed at the first path and the third path in the first embodiment may be inclined, depending on the degrees of the expansion and contraction differences.

In addition, as shown in FIG. 6, the pipe of the coupling device 40 according to the fourth embodiment is formed with a path (hereinafter, will be referred to as a “first path in the fourth embodiment”) that includes the swivel joint 211 and that extends in the vertical direction, a path (hereinafter, will be referred to as a “second path in the fourth embodiment”) that includes the swivel joint 212 and that extends in the vertical direction, a path (hereinafter, will be referred to as a “third path in the fourth embodiment”) that includes the swivel joint 213 and that extends in the vertical direction, and a path (hereinafter, will be referred to as a “fourth path in the fourth embodiment”) that is composed of the tube 414 and that extends in the vertical direction.

The first to third paths in the fourth embodiment are respectively provided with the swivel joints 211 to 213. However, the fourth path in the fourth embodiment is not provided with a swivel joint. Therefore, at the time of thermal expansion of the pipe, there may be an expansion and contraction difference between the third path and the fourth path in the fourth embodiment, but a probability of an expansion and contraction difference between the first path and the second path in the fourth embodiment is low. In addition, a probability of an expansion and contraction difference between the second path and the third path in the fourth embodiment is also low. That is, when the pipe of the coupling device 40 according to the fourth embodiment thermally expands, thermal stress may be generated, and thus the swivel joint 213 disposed at the third path in the fourth embodiment may be inclined, depending on the degree of the expansion and contraction difference.

As described above, in a case where paths of the pipe that are adjacent to each other are a combination of a path with a swivel joint and a path without a swivel joint, a probability of an expansion and contraction difference is high. However, in a case where paths of the pipe that are adjacent to each other are a combination of paths with swivel joints or a combination (not shown) of paths without swivel joints, a probability of an expansion and contraction difference is low. When the first embodiment and the fourth embodiment are compared with each other in this regard, the fourth embodiment in which the number of combinations of a path with a swivel joint and a path without a swivel joint is one is more preferable than the first embodiment in which the number of such combinations is two.

### Fifth Embodiment

### Configuration of Molten Resin Supply System

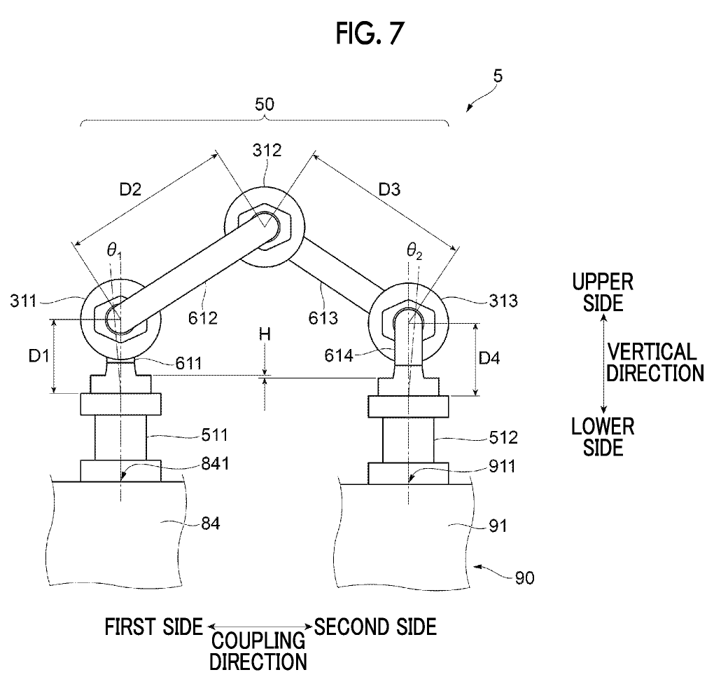

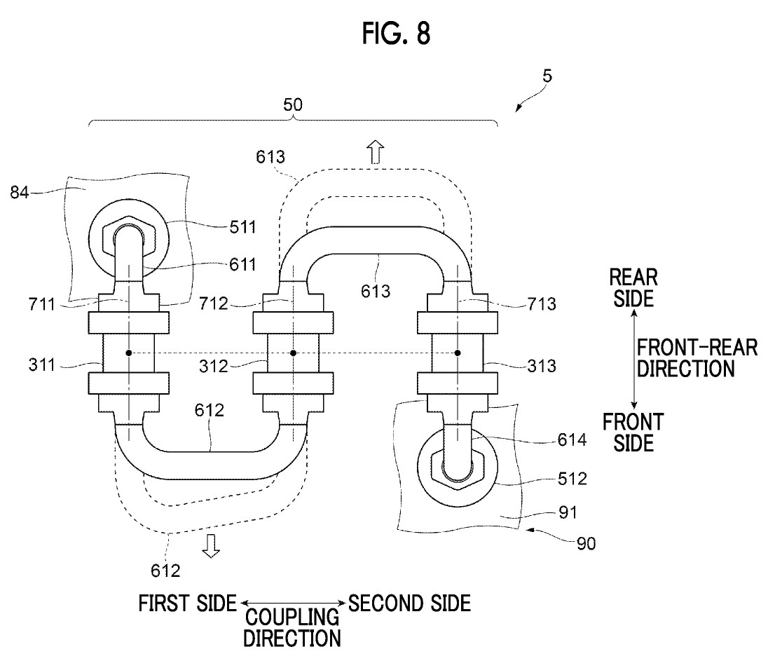

FIGS. 7 and 8 are views showing a part of an external appearance configuration of a molten resin supply system 5 according to a fifth embodiment. FIG. 7 shows a front view of a part of the molten resin supply system 5 as seen in a direction from a front side to a rear side in the front-rear direction. In addition, FIG. 8 shows a plan view of the molten resin supply system 5 as seen in a direction from the upper side to the lower side in the vertical direction.

Although the configuration of the molten resin supply system 5 according to the fifth embodiment is essentially the same as the configurations of the molten resin supply systems 1 to 4 according to the above-described embodiments, the orientation of an outlet (and a connecting member) of a decontamination machine and the orientation of rotary shafts of swivel joints are different from those in the above-described embodiments. That is, the outlets (and the connecting members) of the decontamination machines of the molten resin supply systems 1 to 4 according to the above-described embodiments are oriented such that molten resin is output from the first side to the second side in the coupling direction. In addition, the orientations of the rotary shafts of the swivel joints of the coupling devices of the molten resin supply systems 1 to 4 according to the above-described embodiments are approximately parallel to the vertical direction.

However, an outlet 841 (and a connecting member 511) of a decontamination machine 84 of the molten resin supply system 5 according to the fifth embodiment is oriented such that molten resin is output from the lower side to the upper side in the vertical direction. In addition, the orientation of each of respective rotary shafts 711 to 713 of swivel joints 311 to 313 of a coupling device 50 is not parallel to the vertical direction and is approximately perpendicular to a direction (the coupling direction) in which the plasticizing cylinder moves, that is, approximately parallel to the front-rear direction.

Specifically, the configuration of the coupling device 50 of the molten resin supply system 5 according to the fifth embodiment is as follows. That is, as shown in FIGS. 7 and 8, the coupling device 50 is a device composed of a pipe that couples the decontamination machine 84 disposed on the first side in the coupling direction and the injection molding machine 90 disposed on the second side to each other. The coupling device 50 is composed of tubes 611 to 614, the swivel joints 311 to 313, and connecting members 511 and 512, and is a meandering pipe obtained by coupling the tubes 611 to 614, the swivel joints 311 to 313, and the connecting members 511 and 512 to each other.

The tube 611 is a tube of which one end is connected to the connecting member 511 and of which the other end is connected to the swivel joint 311. That is, the tube 611 has a curved shape that causes molten resin output from the outlet 841 of the decontamination machine 84 to flow toward the swivel joint 311. The tube 612 is a tube of which one end is connected to the swivel joint 311 and of which the other end is connected to the swivel joint 312. The tube 612 has a curved shape that causes molten resin flowing from the swivel joint 311 to flow toward the swivel joint 312.

The tube 613 is a tube of which one end is connected to the swivel joint 312 and of which the other end is connected to the swivel joint 313. The tube 613 has a curved shape that causes molten resin flowing from the swivel joint 312 to flow toward the swivel joint 313. The tube 614 has a curved shape that causes molten resin flowing from the swivel joint 313 to flow toward the inlet 911 of the plasticizing cylinder 91.

The swivel joint 311 is a swivel joint of which an end portion on the rear side in the front-rear direction is connected to the tube 611 and of which an end portion on the front side is connected to the tube 612. The swivel joint 312 is a swivel joint of which an end portion on the front side in the front-rear direction is connected to the tube 612 and of which an end portion on the rear side is connected to the tube 613. The swivel joint 313 is a swivel joint of which an end portion on the rear side in the front-rear direction is connected to the tube 613 and of which an end portion on the front side is connected to the tube 614. Note that the configurations of the connecting members 511 and 512 are the same as the configurations in the first to fourth embodiments described above. Therefore, description thereof will be omitted.

### Comparison between First to Fourth Embodiments and Fifth Embodiment

All of the orientations of the rotary shafts of the swivel joints of the coupling devices of the molten resin supply systems according to the first to fourth embodiments are approximately parallel to the vertical direction. However, the orientation of each of the respective rotary shafts 711 to 713 of the swivel joints 311 to 313 of the coupling device 50 of the molten resin supply system 5 according to the fifth embodiment is not parallel to the vertical direction and is approximately parallel to the front-rear direction.

Since the orientations of the rotary shafts of the swivel joints are different from each other as described above, the coupling device 50 of the molten resin supply system 5 according to the fifth embodiment has advantages as follows with respect to the coupling devices of the molten resin supply systems according to the first to fourth embodiments. That is, a manufacturing error of a coupling device in any of the embodiments may occur, and the manufacturing error may be a cause of a bending moment applied to the inside of a swivel joint. Application of a bending moment to the inside of a swivel joint may result in a decrease in durability of the swivel joint or damage to the swivel joint.

Examples of the manufacturing error of a coupling device include variations in the vertical length of tubes constituting the coupling device, axial offsets of swivel joints constituting the coupling device, and vertical positional offsets of one end and the other end of a pipe constituting the coupling device. As a method for suppressing the occurrence of such manufacturing errors, there is a method of improving the accuracy of each process during manufacture. However, such a method results in an increase in manufacturing costs. In addition, there is a limit to the improvement in accuracy. However, in the case of the coupling device 50 of the molten resin supply system 5 according to the fifth embodiment, even when there are manufacturing errors as described, the manufacturing errors can be canceled out by rotation of the swivel joints 311 to 313.

That is, as manufacturing errors, there may be a variation between respective lengths D1 to D4 of the tubes 611 to 614, an axial offset (angles θ1 and θ2) of each of the swivel joints 311 and 313, and vertical positional offsets (a distance H) of one end and the other end of the pipe. However, the manufacturing errors are canceled out by rotation of the swivel joints 311 to 313.

As described above, according to the coupling device 50 in the fifth embodiment, it is possible to solve a manufacturing error problem that is a cause of a bending moment applied to the insides of the swivel joints 311 to 313 while reducing the manufacturing costs in comparison with a case where the accuracy of each process at the time of manufacture is improved.

In conclusion, the coupling device according to the fifth embodiment of the present invention only needs to have a configuration as follows, and various embodiments can be adopted.

That is, the coupling device 50 of the molten resin supply system 5 according to the fifth embodiment is a coupling device that couples the decontamination machine 84 outputting molten resin to be recycled from the outlet 841 to the injection molding machine 90 including the plasticizing cylinder 91 that includes the inlet 911 through which the output molten resin is input and that heats the molten resin and the injection cylinder 92 (refer to FIG. 2) that is independent of the plasticizing cylinder 91 and that injects the heated molten resin into the mold 93 (refer to FIG. 2), the coupling device coupling the decontamination machine 84 to the injection molding machine 90 with one end of a pipe formed by the tubes 611 to 614 and the swivel joints 311 to 313 through which the molten resin passes being connected to the outlet 841 via the connecting member 511 and the other end of the pipe being connected to the inlet 911 via the connecting member 512.

Here, the orientation of each of the respective rotary shafts 711 to 713 of the swivel joints 311 to 313 may not be parallel to the vertical direction and may be approximately perpendicular to a direction (the coupling direction) in which the plasticizing cylinder 91 moves (approximately parallel to the front-rear direction).

Accordingly, even when there is a manufacturing error of a member constituting the pipe of the coupling device 50, the manufacturing error can be canceled out by rotation of the swivel joints 311 to 313.

### Sixth Embodiment

### Configuration of Molten Resin Supply System

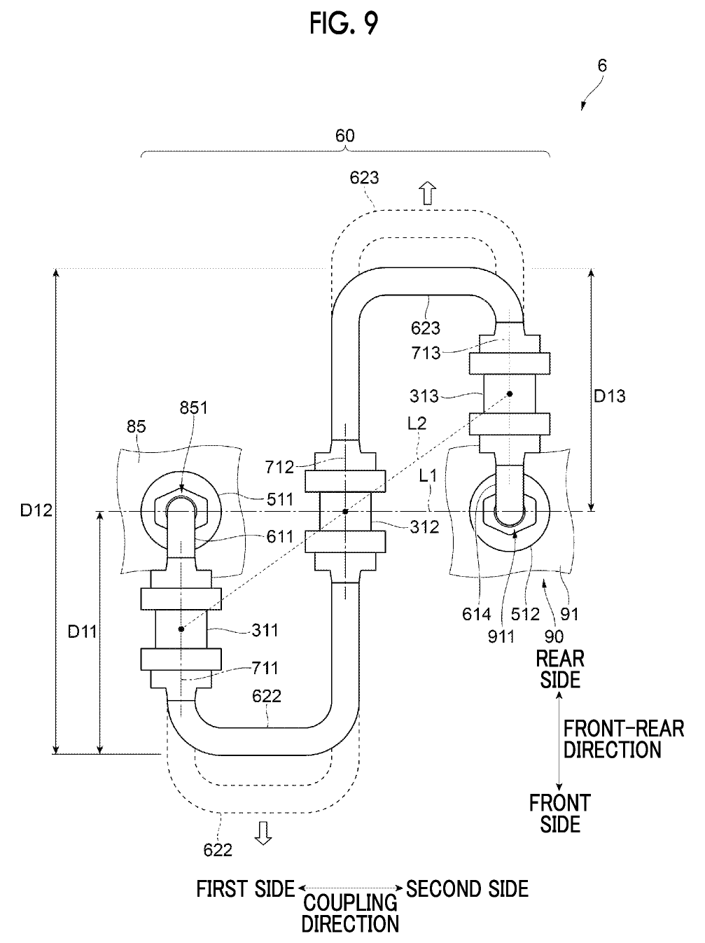

FIG. 9 is a view showing a part of an external appearance configuration of a molten resin supply system 6 according to a sixth embodiment. FIG. 9 shows a plan view of the molten resin supply system 6 as seen in a direction from the upper side to the lower side in the vertical direction.

The configuration of a coupling device 60 of the molten resin supply system 6 according to the sixth embodiment is essentially the same as the configuration of the coupling device 50 of the molten resin supply system 5 according to the fifth embodiment described above. However, the length of some of tubes, the positional relationship between one end and the other end of a pipe, and the positional relationship between three swivel joints are different from those in the fifth embodiment.

Specifically, the configuration of the coupling device 60 according to the sixth embodiment is as follows. That is, as shown in FIG. 9, the coupling device 60 is a device composed of a pipe that couples a decontamination machine 85 disposed on the first side in the coupling direction and the injection molding machine 90 disposed on the second side to each other. The coupling device 60 is composed of tubes 611, 614, 622, and 623, the swivel joints 311 to 313, and the connecting members 511 and 512, and is a meandering pipe obtained by coupling the tubes 611, 614, 622, and 623, the swivel joints 311 to 313, and the connecting members 511 and 512 to each other.

In addition, a virtual straight line L1 connecting one end and the other end of the pipe to each other is approximately parallel to a direction (the coupling direction) in which the plasticizing cylinder 91 moves. In addition, the virtual straight line L1 is approximately orthogonal to each of the respective rotary shafts 711 to 713 of the swivel joints 311 to 313. In addition, a virtual straight line L2 connecting the swivel joints 311 to 313 to each other is not parallel to the virtual straight line L1 (that is, is not parallel to the coupling direction).

Here, in the coupling device of each embodiment, a portion of the pipe that includes a swivel joint disposed closest to the first side in the coupling direction will be referred to as a first pipe portion, and a portion of the pipe that includes a swivel joint disposed closest to the second side in the coupling direction will be referred to as a third pipe portion. In addition, a portion of the pipe that includes a swivel joint disposed between the first pipe portion and the third pipe portion will be referred to as a second pipe portion.

Regarding the pipe of the coupling device 60 according to the sixth embodiment, a length D11 of the first pipe portion including the swivel joint 311 in the front-rear direction is smaller than a length D12 of the second pipe portion including the swivel joint 312 in the front-rear direction. In addition, a length D13 of the third pipe portion including the swivel joint 313 in the front-rear direction is also smaller than the length D12 of the second pipe portion in the front-rear direction. Specifically, it is preferable that each of the length D11 of the first pipe portion in the front-rear direction and the length D13 of the third pipe portion is equal to or smaller than 30% of the length of the second pipe portion. Furthermore, in consideration of safety, it is preferable that each of the length D11 of the first pipe portion in the front-rear direction and the length D13 of the third pipe portion is equal to or smaller than 20% of the length of the second pipe portion.

### Comparison between Fifth Embodiment and Sixth Embodiment

The tube 622 of the coupling device 60 of the molten resin supply system 6 is longer than the tube 612 of the coupling device 50 of the molten resin supply system 5. Specifically, the length of a portion of the tube 622 of the coupling device 60 of the molten resin supply system 6 that constitutes a portion of the second pipe portion is larger than the length of a portion of the tube 612 of the coupling device 50 of the molten resin supply system 5 that constitutes a portion of the second pipe portion.

In addition, the tube 623 of the coupling device 60 of the molten resin supply system 6 is longer than the tube 613 of the coupling device 50 of the molten resin supply system 5. Specifically, the length of a portion of the tube 623 of the coupling device 60 of the molten resin supply system 6 that constitutes a portion of the second pipe portion is larger than the length of a portion of the tube 613 of the coupling device 50 of the molten resin supply system 5 that constitutes a portion of the second pipe portion.

In addition, the positional relationship between the swivel joints 311 to 313 of the coupling device 60 of the molten resin supply system 6 in the front-rear direction and the positional relationship between the swivel joints 311 to 313 of the coupling device 50 of the molten resin supply system 5 in the front-rear direction are different from each other. Specifically, as shown in FIG. 9, the positional relationship between the swivel joints 311 to 313 of the molten resin supply system 6 in the front-rear direction is a positional relationship in which the virtual straight line L2 is not parallel to the virtual straight line L1 (that is, is not parallel to the coupling direction). However, the positional relationship between the swivel joints 311 to 313 of the molten resin supply system 5 in the front-rear direction is a positional relationship in which a virtual straight line L21 connecting the swivel joints 311 to 313 to each other is approximately parallel to the coupling direction, as shown in FIG. 8.

The configuration of the coupling device 60 of the molten resin supply system 6 according to the sixth embodiment has advantages as follows with respect to the coupling device 50 of the molten resin supply system 5 according to the fifth embodiment. That is, as represented by broken lines in FIGS. 8 and 9, thermal distortion in directions along arrows occurs in each of the pipes of the coupling devices 50 and 60 in the embodiments. In addition, the pipe bent due to the thermal distortion may be a cause of a bending moment applied to the inside of a swivel joint.

However, regarding the coupling device 60 according to the sixth embodiment, since the length D11 of the first pipe portion in the front-rear direction, the length D12 of the second pipe portion in the front-rear direction, and the length D13 of the third pipe portion in the front-rear direction are in a relationship as described above, a degree to which thermal distortion of the pipe is allowed is increased. Therefore, in the case of the coupling device 60 according to the sixth embodiment, the pipe is less likely to be bent due to thermal distortion in comparison with the coupling device 50 according to the fifth embodiment.

In conclusion, the coupling device according to the sixth embodiment of the present invention only needs to have a configuration as follows, and various embodiments can be adopted.

That is, the coupling device 60 of the molten resin supply system 6 according to the sixth embodiment is a coupling device that couples the decontamination machine 85 outputting molten resin to be recycled from an outlet 851 to the injection molding machine 90 including the plasticizing cylinder 91 that includes the inlet 911 through which the output molten resin is input and that heats the molten resin and the injection cylinder 92 (refer to FIG. 2) that is independent of the plasticizing cylinder 91 and that injects the heated molten resin into the mold 93 (refer to FIG. 2), the coupling device coupling the decontamination machine 85 to the injection molding machine 90 with one end of a pipe formed by the tubes 611, 614, 622, and 623 and the swivel joints 311 to 313 through which the molten resin passes being connected to the outlet 851 via the connecting member 511 and the other end of the pipe being connected to the inlet 911 via the connecting member 512.

In addition, the virtual straight line L1 connecting one end and the other end of the pipe to each other may be approximately parallel to a direction (the coupling direction) in which the plasticizing cylinder 91 moves.

In addition, the virtual straight line L1 connecting the one end and the other end of the pipe to each other may be approximately orthogonal to each of the respective rotary shafts 711 to 713 of the swivel joints 311 to 313.

In addition, each of the length D11 of the first pipe portion of the pipe that includes the swivel joint 311 closest to one end connected to the outlet 851 and the length D13 of the third pipe portion of the pipe that includes the swivel joint 313 farthest from the one end connected to the outlet 851 may be equal to or smaller than 30% of the length D12 of the second pipe portion of the pipe that includes the swivel joint 312 disposed between the first pipe portion and the third pipe portion.

Accordingly, thermal distortion generated in the pipe is likely to be canceled out, and thus the pipe is less likely to be bent due to the thermal distortion.

### Seventh Embodiment

### Configuration of Molten Resin Supply System

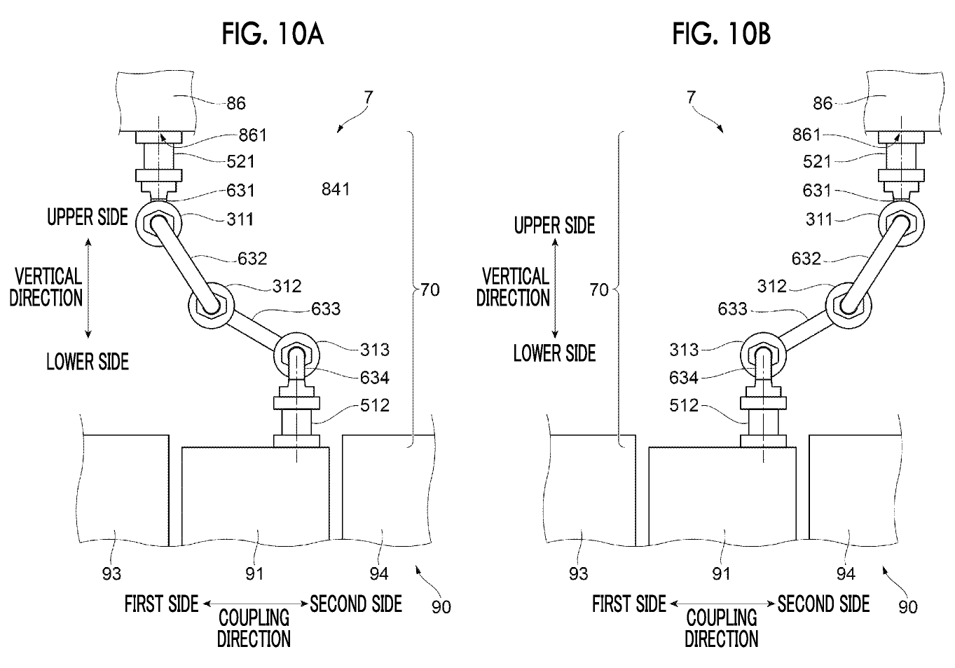

FIGS. 10A and 10B are views showing a part of an external appearance configuration of a molten resin supply system 7 according to a seventh embodiment. FIGS. 10A and 10B show front views of the molten resin supply system 7 as seen in a direction from the front side to the rear side in the front-rear direction. Note that FIG. 10A shows an example of a case where the position of an outlet 861 of a decontamination machine 86 is on the first side in the coupling direction with respect to the plasticizing cylinder 91 of the injection molding machine 90. In addition, FIG. 10B shows an example of a case where the position of the outlet 861 of the decontamination machine 86 is on the second side in the coupling direction with respect to the plasticizing cylinder 91 of the injection molding machine 90.

Specifically, the configuration of the coupling device 70 according to the seventh embodiment is as follows. That is, as shown in FIGS. 10A and 10B, the coupling device 70 is a device composed of a pipe that couples the outlet 861 of the decontamination machine 86 disposed on the upper side in the vertical direction and the injection molding machine 90 disposed on the lower side to each other. The coupling device 70 is composed of tubes 631, 632, 633, and 634, the swivel joints 311 to 313, and the connecting members 512 and 521, and is a meandering pipe obtained by coupling the tubes 631, 632, 633, and 634, the swivel joints 311 to 313, and the connecting members 512 and 521 to each other.

Although the configuration of the molten resin supply system 7 according to the seventh embodiment is essentially the same as the configuration of each of the molten resin supply systems 5 and 6 according to the fifth and sixth embodiments described above, the position of the outlet 861 of the decontamination machine 86 in the vertical direction is different from that in the fifth and sixth embodiments as described above.

Such a configuration is a configuration that may be adopted, for example, when there is a restriction on a device disposition space as follows. That is, it will be assumed that a motor 94 or the like needs to be disposed on the second side in the coupling direction with respect to the plasticizing cylinder 91 and that the mold 93 needs to be disposed on the first side in the injection molding machine 90, as shown in FIGS. 10A and 10B. In this case, it is difficult to secure a space for disposition of the coupling device 70 in the vicinity of the mold 93. Here, for example, when the outlet 861 of the decontamination machine 86 is caused to be disposed on the lower side in the vertical direction so that the coupling device 70 is disposed in the vicinity of the mold 93, it is difficult to secure a maintenance space for the injection molding machine 90.

In conclusion, in consideration of the maintainability of the injection molding machine 90, it is preferable that the outlet 861 of the decontamination machine 86 is disposed on the upper side in the vertical direction with respect to the injection molding machine 90 and the coupling device 70. Here, furthermore, in consideration of securing the maintenance space and preventing interference with the motor 94 or the like, it is preferable that the outlet 861 of the decontamination machine 86 is disposed in a direction away from the motor 94 or the like (the first side in the coupling direction). That is, a configuration shown in FIG. 10A is more preferable than a configuration shown in FIG. 10B. Accordingly, the risk of interference between the coupling device 70 and the motor 94 or the like that occurs at the time of expansion and contraction of the coupling device 70 can be lowered.

It should be understood that the invention is not limited to the above-described embodiment, but may be modified into various forms on the basis of the spirit of the disclosure. Additionally, the modifications are included in the scope of the disclosure.

What is claimed is:

1. A coupling device that couples an output unit outputting molten resin to be recycled from an outlet to an injection molding machine including a plasticizing cylinder that includes an inlet through which the output molten resin is input and that heats the molten resin and an injection cylinder that is independent of the plasticizing cylinder and that injects the heated molten resin into a mold, the coupling device comprising:
tubes and swivel joints through which the molten resin passes,
wherein the coupling device couples the output unit to the injection molding machine with one end of a pipe formed by the tubes and the swivel joints being connected to the outlet and the other end of the pipe being connected to the inlet.

2. The coupling device according to claim 1,
wherein the number of the swivel joints provided for the coupling device is three.

3. The coupling device according to claim 1,
wherein the swivel joints include seal members, each having a predetermined heat-proof temperature and a predetermined proof pressure.

4. The coupling device according to claim 1,
wherein the coupling device heats the molten resin passing through the pipe by heating the pipe.

5. The coupling device according to claim 4,
wherein the coupling device heats the pipe using a band heater.

6. The coupling device according to claim 1,
wherein the swivel joints are rotatable via sliding bearings, and a portion of the molten resin is used as a lubricant for the sliding bearings.

7. The coupling device according to claim 1,
wherein orientations of rotary shafts of the swivel joints are not parallel to a vertical direction and are perpendicular to a direction in which the plasticizing cylinder moves.

8. The coupling device according to claim 1,
wherein a virtual straight line connecting the one end and the other end of the pipe to each other is parallel to a direction in which the plasticizing cylinder moves.

9. The coupling device according to claim 1,
wherein a virtual straight line connecting the one end and the other end of the pipe to each other is orthogonal to rotary shafts of the swivel joints.

10. The coupling device according to claim 2,
wherein each of a length of a first pipe portion of the pipe that includes a swivel joint closest to the one end and a length of a third pipe portion of the pipe that includes a swivel joint farthest from the one end is equal to or smaller than 30% of a length of a second pipe portion of the pipe that includes a swivel joint disposed between the first pipe portion and the third pipe portion.

11. The coupling device according to claim 1, further comprising:
a connecting member including an end portion of the connecting member on an upper side in a vertical direction connected to the tube and an end portion of the connecting member on a lower side in the vertical direction connected to the inlet of the plasticizing cylinder.

12. The coupling device according to claim 11,
wherein the pipe has a meandering shape meandering in the vertical direction by coupling the tubes, the swivel joints, and the connecting members.

13. The coupling device according to claim 12,
wherein the connecting member and the tube are connected to each other with a rubber O-ring as a sealing member interposed therebetween.

14. A molten resin supply system comprising:
the output unit;
the injection molding machine; and
the coupling device according to claim 1,
wherein a position of the outlet of the output unit is fixed, and a position of the inlet of the plasticizing cylinder is moved in accordance with positional movement of the plasticizing cylinder.

15. A molten resin supply system comprising:
the output unit;
the injection molding machine; and
the coupling device according to claim 1,
wherein virtual straight lines that connect respective rotary shafts of three swivel joints to each other do not form one straight line as seen in a vertical direction even when the output unit and the injection molding machine are relatively moved or a process of preventing the virtual straight lines from forming one straight line as seen in the vertical direction is performed, the three swivel joints being coupled to each other via two tubes.

16. The molten resin supply system according to claim 14,
wherein the output unit or the injection molding machine performs control for reducing internal pressures of the swivel joints depending on magnitudes of the internal pressures of the swivel joints.

17. The molten resin supply system according to claim 16,
wherein the output unit or the injection molding machine performs, as the control, control for lowering a pressure at which the molten resin is output from the outlet.

18. The molten resin supply system according to claim 17,
wherein the output unit or the injection molding machine performs, as the control, control of at least one of outputting of the molten resin from the output unit and inputting of the molten resin to the injection molding machine.

19. The molten resin supply system according to claim 16,
wherein the output unit calculates the magnitudes of the internal pressures based on information detected at each of molten resin inlets and molten resin outlets of the swivel joints.

20. The molten resin supply system according to claim 14,
wherein a position of the outlet of the output unit in a vertical direction and a position of the inlet of the injection molding machine in the vertical direction are on the same horizontal straight line.
